(19) United States
(12) Patent Application Publication
(10) Pub. No.: US 2014/0106787 A1
(43) Pub. Date: Apr. 17, 2014

(54) INFORMATION TERMINAL, INFORMATION TERMINAL CONTROL METHOD, AND RECORDING MEDIUM

(71) Applicant: Tomohisa Hangai, Osaka-shi (JP)

(72) Inventor: Tomohisa Hangai, Osaka-shi (JP)

(73) Assignee: SHARP KABUSHIKI KAISHA, Osaka-shi, Osaka (JP)

(21) Appl. No.: 14/124,622

(22) PCT Filed: Jun. 8, 2012
(86) PCT No.: PCT/JP2012/064847

§ 371 Date: Dec. 6, 2013

(30) Foreign Application Priority Data
Jun. 10, 2011 (JP) 2011-130603
Jun. 10, 2011 (JP) 2011-130605

(51) Int. Cl. H04M 1/725; H04W 12/00; H04W 4/02

(52) U.S. Cl. CPC H04M 1/72572; H04W 4/02; H04W 12/00
USPC 455/456.4; 455/566

(57) ABSTRACT

A mobile phone 1 is arranged such that a display section (40) displays an image of image data carrying positional information which image data is stored in a storing section (40) and a security setting section (510) (i) specifies security setting information indicative of a content of a limitation on a function of the mobile phone 1 and (ii) stores, in the storing section (40), the security setting information in association with the image data.

### TECHNICAL FIELD

The present invention relates to an information terminal having a security function, a method for controlling the information terminal, a control program for controlling the information terminal, and a recording medium for controlling the information terminal.

### BACKGROUND ART

In recent years, with the prevalence of information terminals having a security function, many models of information terminals which obtain their positional information by a GPS-based positioning device or the like, and then carry out security management in accordance with the positional information thus obtained have been developed one after another.

For example, Patent Literature 1 discloses an information processing device which carries out security management by use of positional information. Specifically, the information processing device performs such positional information-based security management in which the information processing device obtains positional information on the information processing device, and then puts a limit on a function under the security management with reference to security policy data, which is data for determining, in accordance with the positional information, what function of the information processing device is to be limited.

Moreover, Patent Literature 2 discloses a storing device having a security function. Specifically, the storing device, which is configured such that a place where the storing device is to be located is predetermined, detects a position of the storing device, and compares the place predetermined with the position thus detected. In a case where the position thus detected is different from the place predetermined, the storage device prohibits its access to a storage medium.

Further, Patent Literature 3 discloses a mobile terminal information management system whose purpose is to simultaneously provide convenience and security of information, which conflict with each other. Specifically, the mobile terminal information management system performs such transfer of display information that display information to be stored in a memory card is transferred to either one of a first storing section or a second storing section, which is determined in accordance with where is a current position of a user. That is, in a case where the mobile terminal information management system determines that update positional information on the user does not correspond to the last positional information on the user, the mobile terminal information management system determines, in accordance with the update positional information on the user, a storing position which indicates that display information, stored in one of the memory card, the first storing section, and the second storing section, is to be stored in which one of the other two storage sections.

### CITATION LIST

Patent Literature 1
Japanese Patent Application Publication, Tokukai, No. 2009-070073 A (Publication Date: Apr. 2, 2009)

Patent Literature 2
Japanese Patent Application Publication, Tokukai, No. 2009-259115 A (Publication Date: Nov. 5, 2009)

Patent Literature 3
Japanese Patent Application Publication, Tokukai, No. 2010-086165 A (Publication Date: Apr. 15, 2010)

### SUMMARY OF INVENTION

### Technical Problem

However, in a case where (i) security management is carried out in accordance with positional information and (ii) the positional information is preregistered in association with a security function, the positional information is conventionally indicated by a longitude and a latitude or the like. This has caused the following problem. That is, it is difficult for a user of an information terminal to understand a place indicated by the positional information. Further, it is troublesome to register the positional information in association with the security function. Moreover, in a case where the user wants to confirm or change information regarding the association between the positional information and the security function thus registered, it is difficult for the user to understand what limitation is set for what place (positional information).

For example, the technique disclosed in Patent Literature 1 is a technique to limit a function in accordance with positional information, with reference to security policy data. In order to register the security policy data, it is necessary to obtain the positional information. However, Cited Document 1 does not specifically describe how to obtain the positional information. Further, it is difficult to confirm which area includes a place where the function is limited. Moreover, it is troublesome to change the area.

Further, the technique disclosed in Patent Literature 2 is a technique to prohibit access to a storage medium in a case where a position detected is different from a place predetermined. However, as in the case of Patent Literature 1, a user cannot know how to register a place to be predetermined or how to confirm or change the place predetermined. Therefore, such registration, confirmation, or change of the place is not easy for the user.

Moreover, the technique disclosed in Patent Literature 3 is a technique to determine a storage position by comparing update positional information on a user with the last positional information on the user. However, the positional information and the security function are not preregistered in association with each other. Therefore, the user cannot manage the security function in accordance with the place predetermined.

The present invention was made in view of the problems, and an object of the present invention is to provide (i) an information terminal which allows positional information and a security function to be easily registered in association and to be easily confirmed or changed later, (ii) a method for controlling the information terminal, (iii) a control program for controlling the information terminal, and (iv) a recording medium for controlling the information terminal.

### Solution to Problem

In order to attain the above object, an information terminal of the present invention is an information terminal which limits a function of the information terminal in accordance with a current position of the information terminal, includes: a display section for displaying an image; a storing section for storing image data carrying positional information, the image data being image data to which positional information is added; and a function limit setting means for (i) causing the display section to display an image of the image data carrying positional information, (ii) specifying function limit setting information indicative of a content of a limitation on a function of the information terminal, and (iii) storing, in the storing section, the function limit setting information in association with the image data carrying positional information.

Further, a method for controlling an information terminal of the present invention is a method for controlling an information terminal which limits a function of the information terminal in accordance with a current position of the information terminal, the information terminal including: a display section for displaying an image; and a storing section for storing image data carrying positional information, the image data being image data to which positional information is added, the method including the steps of (i) causing the display section to display an image of the image data carrying positional information, (ii) specifying function limit setting information indicative of a content of a limitation on a function of the information terminal and (iii) storing, in the storing section, the function limit setting information in association with the image data carrying positional information.

According to the above configuration, the information terminal which limits the function of the information terminal in accordance with the current position of the information terminal is arranged such that the function limit setting information, indicative of the content of the limitation on the function of the information terminal, is (i) associated with the image data carrying positional information, which image data is image data to which the positional information is added, and (ii) stored in the storing section. Therefore, according to the information terminal, in a case where the function of the information terminal is limited in accordance with the current position of the information terminal, it is possible to limit the function of the information terminal with the use of the function limit setting information associated with the image data carrying positional information, which image data is image data to which the positional information indicative of a position near the current position is added, with reference to the positional information added to the image data carrying positional information.

Particularly, according to the information terminal, it is not the positional information but the image data that is directly associated with the function limit setting information. This allows the user to set or change the function limit while looking at the image, in a case where the user sets or changes the function limit by associating the function limit setting information with the positional information. Since the user can specifically recognize, as an image, which place the position indicated by the positional information indicates, the user can easily set or change the function limit. Obviously, the image data carrying positional information is preferably image data (i) which is of an object located at a position at which the user desires to set the function limit and (ii) to which positional information such as a longitude and a latitude of the position is added.

Note that the information terminal can be realized by a computer. In this case, the scope of the present invention encompasses (i) a control program of the information terminal which control program realizes the information terminal by causing the computer to function as each means of the information terminal and (ii) a computer-readable recording medium in which the control program is recorded.

### Advantageous Effects of Invention

As described above, an information terminal of the present invention includes: a display section for displaying an image; a storing section for storing image data carrying positional information, the image data being image data to which positional information is added; and a function limit setting means for (i) causing the display section to display an image of the image data carrying positional information, (ii) specifying function limit setting information indicative of a content of a limitation on a function of the information terminal, and (iii) storing, in the storing section, the function limit setting information in association with the image data carrying positional information.

Further, according to a method for controlling an information terminal of the present invention, the information terminal includes: a display section for displaying an image; and a storing section for storing image data carrying positional information, the image data being image data to which positional information is added, the method includes the steps of (i) causing the display section to display an image of the image data carrying positional information, (ii) specifying function limit setting information indicative of a content of a limitation on a function of the information terminal and (iii) storing, in the storing section, the function limit setting information in association with the image data carrying positional information.

According to the above configuration, it is not the positional information but the image data that is directly associated with the function limit setting information. This allows the user to set or change the function limit while looking at the image, in a case where the user sets or changes the function limit by associating the function limit setting information with the positional information. Since the user can specifically recognize, as an image, which place the position indicated by the positional information indicates, the user can easily set or change the function limit.

### BRIEF DESCRIPTION OF DRAWINGS

FIG. 1 is a block diagram illustrating a main part of a configuration of a mobile phone of an embodiment of the present invention.

(a) and (b) of FIG. 2 are each a view illustrating an example of an outline of a process carried out by the mobile phone illustrated in FIG. 1.

(a) and (b) of FIG. 3 are each a view illustrating an example of a management table for use in the mobile phone illustrated in FIG. 1. On the management table, setting information regarding a security function is stored.

FIG. 4 is a flowchart illustrating an example of how the mobile phone illustrated in FIG. 1 carries out security setting.

(a) through (g) of FIG. 5 are each a screen transition diagram illustrating an example of how the mobile phone illustrated in FIG. 1 carries out the security setting.

FIG. 6 is a flowchart illustrating an example of how the mobile phone illustrated in FIG. 1 switches over the security function.

(a) and (b) of FIG. 7 are each a view illustrating a basic pattern observed in the use of the mobile phone illustrated in FIG. 1, in a case where there are a plurality of images whose effective areas each include a current position.

FIG. 8 is a block diagram illustrating a main part of a configuration of a mobile phone of another embodiment of the present invention.

FIG. 9 is a flowchart illustrating an example of how the mobile phone illustrated in FIG. 8 carries out security setting.

(a) through (h) of FIG. 10 are each a screen transition diagram illustrating an example of how the mobile phone illustrated in FIG. 8 carries out the security setting.

FIG. 11 is a flowchart illustrating an example of how a mobile phone, of further another embodiment of the present embodiment, carries out security setting.

(a) through (d) of FIG. 12 are each a screen transition diagram illustrating an example of how the mobile phone illustrated in FIG. 11 carries out the security setting.

FIG. 13 is a tree-chart illustrating a relationship between setting folders and image files, according to the mobile phone illustrated in FIG. 11.

FIG. 14 is a flowchart illustrating an example of how the mobile phone illustrated in FIG. 11 switches over a security function.

FIG. 15 is a flowchart illustrating an example of how a mobile phone, of further another embodiment of the present invention, carries out security setting.

(a) through (c) of FIG. 16 are each a screen transition diagram illustrating an example of how the mobile phone illustrated in FIG. 15 carries out the security setting.

(a) through (d) of FIG. 17 are each a view illustrating an examples of an Exif information area and a security function effective state management table of an image file, for use in an mobile phone of further another embodiment of the present invention. The Exif information area and the security function effective state management table each store setting information on a security function.

FIG. 18 is a block diagram illustrating a main part of a configuration of the mobile phone illustrated in FIG. 17.

FIG. 19 is a flowchart illustrating an example of how the mobile phone illustrated in FIG. 18 carries out security setting.

FIG. 20 is a block diagram illustrating a main part of a configuration of a mobile phone of further another embodiment of the present invention.

FIG. 21 is a flowchart illustrating an example of how the mobile phone illustrated in FIG. 20 carries out the security setting.

FIG. 22 is a flowchart illustrating an example of how a mobile phone, of further another embodiment of the present invention, carries out security setting.

### DESCRIPTION OF EMBODIMENTS

The following description will discuss an information terminal of an embodiment of the present invention with reference to the drawings. Note that the information terminal of the present embodiment is provided as a mobile phone. Therefore, the following description will simply refer to the information terminal of the present embodiment as a mobile phone.

However, the present invention is not limited to the mobile phone, but is generally applicable to general information terminals having a security function.

### First Embodiment

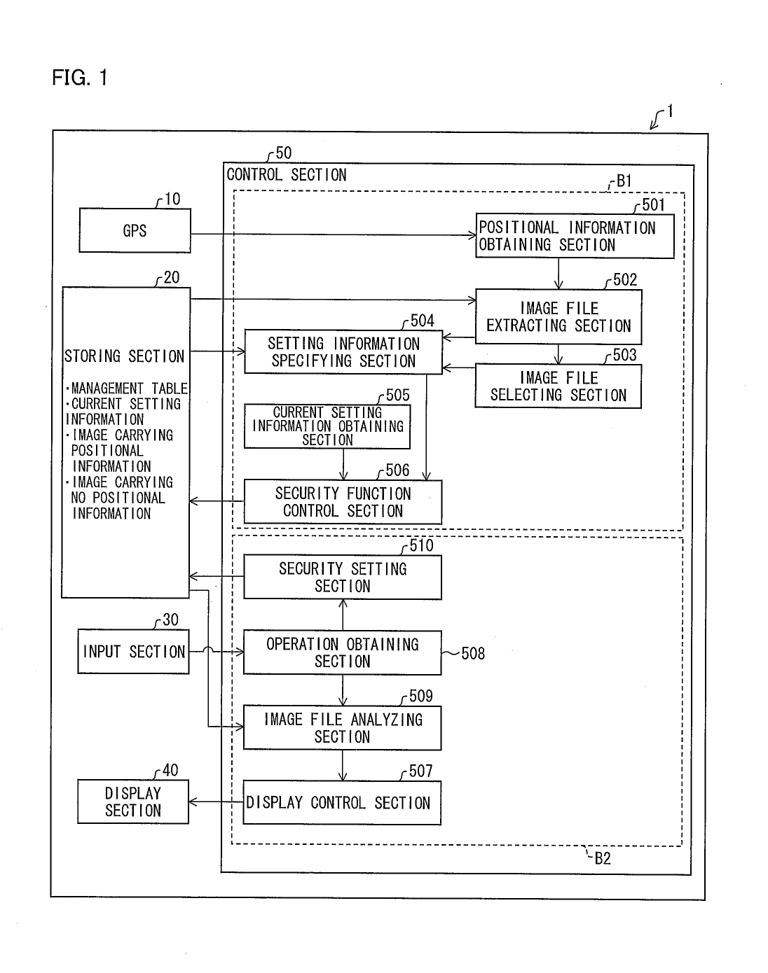

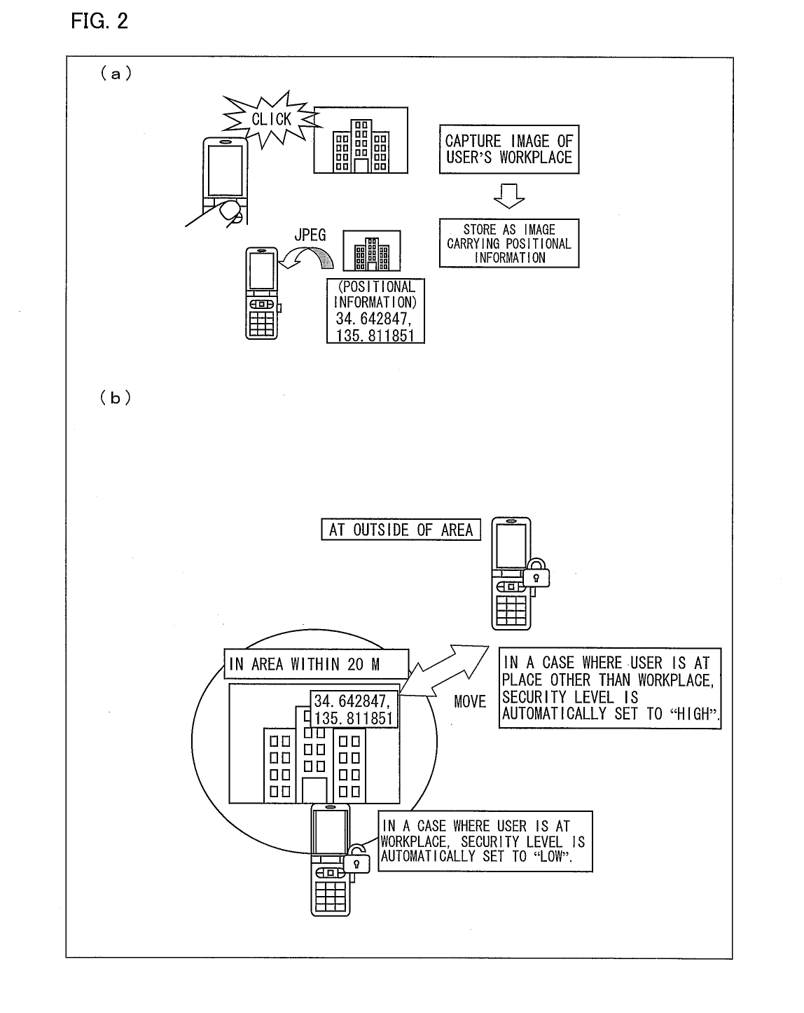

The following description will discuss an embodiment of the present invention with reference to FIGS. 1 through 7.

(Outline of Process)

The following description will discuss an outline of a process carried out in the present embodiment with reference to FIG. 2. FIG. 2 is a view illustrating an example of an outline of a process carried out in a plurality of embodiments including the present embodiment. FIG. 2 illustrates an example in which security management is carried out by separating positions by a workplace and a place other than the workplace. (a) of FIG. 2 is a view illustrating a situation in which an image captured by a camera is stored together with positional information. (b) of FIG. 2 is a view illustrating a situation in which a security level is changed in accordance with the positional information.

First, a user captures an image of his/her workplace with a camera (see (a) of FIG. 2). After the user captures the image, a mobile phone 1 (information terminal; see FIG. 1) adds, to the image thus captured, positional information indicative of a place at which the image has been captured (that is, positional information on a place near the workplace), and stores the image to which the positional information is added.

Thereafter, the mobile phone 1 carries out security setting. Note that the security setting herein is setting of a security level and an effective area.

For example, the security level herein is set to “low” and the effective area herein is set to “20 m” (i.e., 20 meters) (a specific setting method will be described later). In this case, the mobile phone 1 carries out security management so that the security level is set to “low” in an area within a 20-meter radius from the place indicated by the positional information which is added to the image and so that the security level is set to “high” in outside of the above area.

In a case where the user who has the mobile phone 1 is at the workplace (i.e., in a case where the user who has the mobile phone 1 is in the area within a 20-meter radius from the place indicated by the positional information added to the image captured), the mobile phone 1 automatically sets the security level to “low” (see (b) of FIG. 2). Meanwhile, in a case where the user is at a place other than the workplace (i.e., in a case where the user who has the mobile phone 1 is in the outside of the above area), the mobile phone 1 automatically sets the security level to “high”.

Next, the following description will discuss the security level and the effective area with reference to FIG. 3.

FIG. 3 is a view illustrating an example of a management table for use in the plurality of embodiments including the present embodiment. On the management table, setting information regarding the security function is stored. (a) of FIG. 3 is a management table indicative of a security state corresponding to each of the images. (b) of FIG. 3 is a management table indicative of an effective state of the security function corresponding to each of the security levels.

For example, a row corresponding to a number “1” indicates that the security level is set to “high” in an effective area within a “20-meter” radius from a place indicated by positional information added to an image file “IMG0001.jpg” (see (a) of FIG. 3).

Further, it is defined that, in a case where the security level is “high”, the security function is set to ON with respect to functions of, for example, “Standby Screen”, “Mail”, “Telephone”, “Telephone Book”, and “Image List” (see (b) of FIG. 3). That is, in a case where the security level is set to “high”, the user cannot use the above five functions.

Moreover, for example, a row corresponding to a number “3” illustrated in (a) of FIG. 3 indicates that the security level is set to “low” in an effective area within a “100-meter” radius from a place indicated by positional information added to an image file “dcf0023.jpg”.

Further, it is defined that, in a case where the security level is “low”, the security function is set to OFF with respect to functions other than, for example, the “Telephone Book” function and that the security function is set to ON with respect to the “Telephone Book” function (see (b) of FIG. 3). That is, in a case where the security level is set to “low”, only the use of the “Telephone Book” function is limited, and the use of the functions other than the “Telephone Book” function (i.e., “Standby Screen”, “Mail”, “Telephone”, and “Image List”) is allowed.

According to the present embodiment, positional information is added to all image files included in a “file name” row in the management table illustrated in (a) of FIG. 3. According to the present embodiment, positional information is added to an image file by adding the positional information such as a geotag to Exif data of the image file. Note that a method for adding the positional information to the image file is not particularly limited. It is only necessary that the image file and the positional information can be managed in association with each other. As with the present embodiment, the positional information and the image file can be retained as one single set of data. Alternatively, the positional information and the image file can be retained as individual sets of data. That is, the positional information and the image file can be retained as individual sets of data and can be managed in association with each other by use of the management table.

Further, according to the present embodiment, the effective state of the security function on the management table illustrated in (b) of FIG. 3 can be predetermined one or can be changed by a user's operation.

Moreover, according to the present embodiment, the security level is always “high” in outside of the effective area. Note that the security level in the outside of the effective area can be changed by a user's operation.

Furthermore, the outline of the process in accordance with the present embodiment is not limited to the outline of the process illustrated in FIG. 2.

For example, in regard to the case illustrated in (a) of FIG. 2, an image to be used as an image carrying the positional information is not limited to an image which has been captured by a camera of the mobile phone 1. Alternatively, an image which has been transmitted from an external device can be used. Further, positional information does not need to be added to the image from the beginning. Alternatively, the positional information can be later added to the image by use of software, such as Kashmir and AbleCV, which adds positional information to an image file.

Further, in regard to the case illustrated in (b) of FIG. 2, as described above, in a case where the security function is managed, the security function for each of a plurality of functions can be switched on/off collectively according to the security level with reference to the management table illustrated in (b) of FIG. 3. Alternatively, in such a case, the security function can be switched on/off individually for each function (e.g., “Mail”, “Telephone”, and the like) in accordance with whether or not the mobile phone is in the effective area.

(Main Part of Configuration of Mobile Phone)

The following description will discuss a configuration of the mobile phone 1 of the present embodiment with reference to FIG. 1. FIG. 1 is a block diagram illustrating a main part of a configuration of the mobile phone 1.

The mobile phone 1 includes a GPS 10, a storing section 20, an input section 30, a display section 40, and a control section 50 (see FIG. 1). Note that the mobile phone 1 can also include another member such as a speaker, a microphone, and a battery. However, such a member is not concerned with the feature of the present invention, and is therefore not illustrated in FIG. 1.

The GPS 10 measures a longitude, a latitude, and an altitude of a current position upon receipt of an electric wave transmitted from an artificial satellite. Note that the present embodiment is not limited to a GPS, provided that a current position is specified. For example, a member can be employed which receives a current position from a base station by communicating with the base station.

In the storing section 20, (i) a control program and an OS program which are executed by the control section 50 and (ii) various sets of data which are read out by the control section 50 in a case where the control section 50 carries out various functions of the mobile phone 1 (e.g., security setting, switch of the security function, and the like (described later)) are stored. According to the present embodiment, data, such as image data, management tables ((a) and (b) of FIG. 3), and current security setting information, is stored in the storing section 20. The storing section 20 is realized, for example, by a rewritable non-volatile memory such as an EPROM, an EEPROM (registered trademark), and a flash memory. Note that a storing section in which information that is not necessary to be rewritten is stored can be realized by a read-only semiconductor memory, such as a ROM (not illustrated), and can be provided in addition to the storing section 20.

The input section 30 generates an instruction signal upon receipt of a user's operational instruction.

The display section 40 displays an image in accordance with an instruction from the control section 50. It is only necessary that the display section 40 display an image in accordance with the instruction from the control section 50. For example, an LCD (Liquid Crystal Display), an organic EL display, a plasma display, and the like are applicable to the display section 40.

The control section 50 carries out various operations and integrally controls each section of the mobile phone 1, by executing a program which is read out from the storing section 20 to a temporary storing section (not illustrated).

Note that, for convenience of description, the control section 50 is illustrated in such a way that a block B1 enclosed by a broken line is a functional block which switches the security function, whereas a block B2 enclosed by another broken line is a functional block which carries out the security setting.

According to the present embodiment, the control section 50 includes, as the block B1, a positional information obtaining section 501 (positional information obtain means), an image file extracting section 502, an image file selecting section 503, a setting information specifying section 504, a current setting information obtaining section 505, and a security function control section 506. Further, the control section 50 includes, as the block B2, a display control section 507, an operation obtaining section 508, an image file analyzing section 509, and a security setting section 510 (function limit setting means). Each of those sections (501 through 510) of the control section 50 can be realized in a case where a CPU (i) reads out a program stored in a storing device realized by a ROM or the like to a temporary storing section realized by a RAM or the like and (ii) executes the program thus read out.

First, the following description will discuss each section of the block B1.

The positional information obtaining section 501 reads out positional information on a longitude and a latitude which are obtained from the GPS 10.

The image file extracting section 502 extracts, from images each carrying positional information which images are stored in the storing section 20, an image carrying, in an effective area associated with the image (see (a) of FIG. 3), the positional information which has been read out by the positional information obtaining section 502.

The image file selecting section 503 selects (sorts out) one image in accordance with a method for determining a priority (described later) in a case where the image file extracting section 502 extracts a plurality of images.

The setting information specifying section 504 specifies, in accordance with the one image extracted (or selected), a security level with reference to the management table illustrated in (a) of FIG. 3. Then, with reference to the management table illustrated in (b) of FIG. 3, the setting information specifying section 504 specifies security setting information (function limit setting information) on each function in accordance with the security level thus specified.

The current setting information obtaining section 505 obtains current security setting information from the storing section 20.

The security function control section 506 compares the security setting information specified by the setting information specifying section 504 with the current security setting information obtained by the current setting information obtaining section 505. In a case where the security setting information is different from the current security setting information, the security function control section 506 changes a security state in accordance with the security setting information specified by the setting information specifying section 504.

Next, the following description will discuss each section of the block B2.

The display control section 507 generates an image to be displayed on the display section 40 and supplies the image thus generated to the display section 40.

The operation obtaining section 508 obtains an instruction signal generated by the input section 30.

The image file analyzing section 509 analyzes whether or not positional information is added to an image file. In a case where positional information is added to the image file, the image file analyzing section 509 extracts the positional information. Further, the image file analyzing section 509 analyzes whether or not information, such as a security level and an effective area, is associated with the image file. In a case where the information is associated with the image file, the image file analyzing section 509 extracts the information.

The security setting section 510 (i) associates the security setting information inputted by the user and the image selected by the user, each of which has been obtained by the operation obtaining section 508, and (ii) stores the security setting information and the image thus associated with each other in the management table illustrated in (a) of FIG. 3.

(Flow of Security Setting)

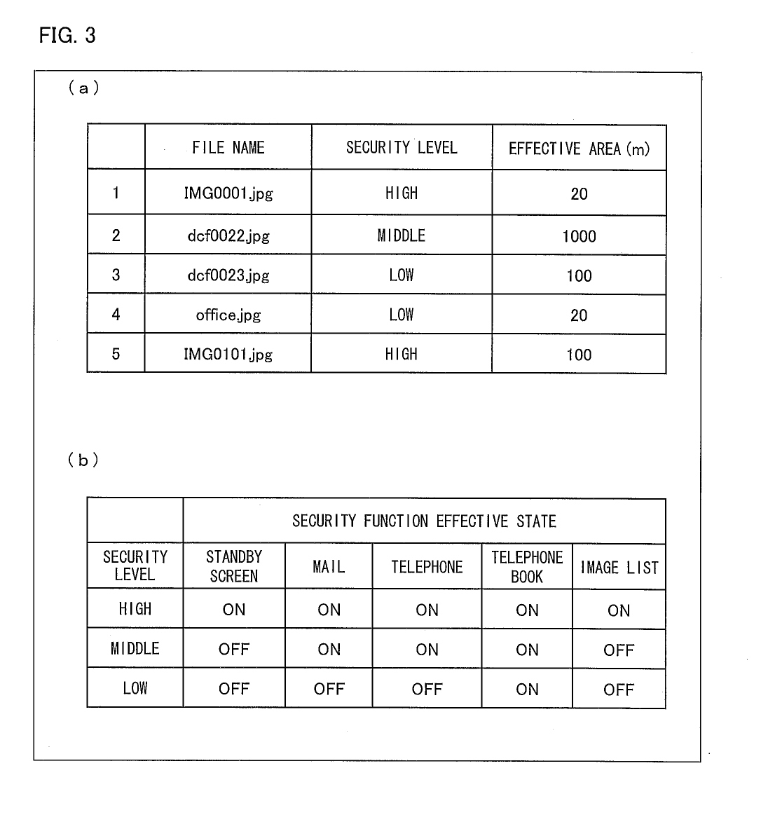

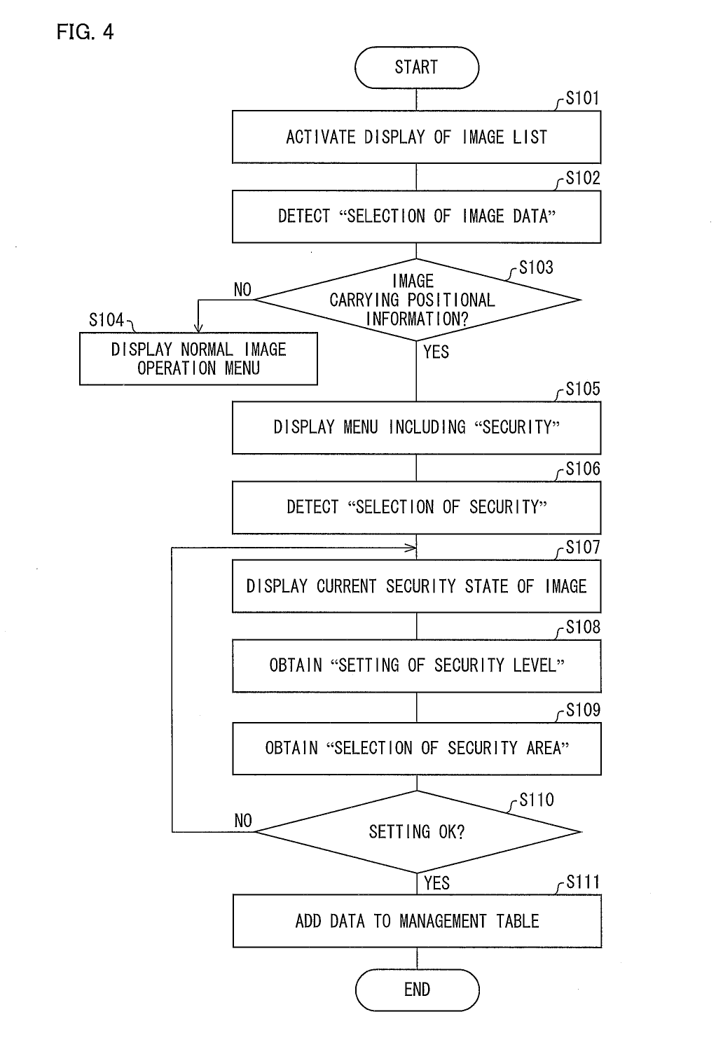

The following description will discuss, with reference to FIGS. 4 and 5, how the mobile phone 1 carries out the security setting. FIG. 4 is a flowchart illustrating an example of how the mobile phones 1 and 5 each carry out the security setting. FIG. 5 is a screen transition diagram illustrating an example of how the mobile phones 1 and 5 each carry out the security setting.

First, the display control section 507 makes a list of images stored in the mobile phone 1, and controls the display section 40 to display the list of the images (see FIG. 4) (S101). (a) of FIG. 5 is a view illustrating an example of an image list screen displayed on the display section 40. Note here that the list may include an image carrying no positional information.

Next, in a case where image data is selected by press-and-hold operation or the like, the operation obtaining section 508 detects an input of “selection of image data” (S102). Then, the operation obtaining section 508 notifies the image file analyzing section 509 of information which specifies the image data thus selected (i.e., a “file name” according to the present embodiment).

Next, the image file analyzing section 509 (i) reads out the image file from the storing section 20 in accordance with the “file name”, which has been notified by the operation obtaining section 508, and (ii) analyzes whether or not positional information is added to the image file (S103). In a case where the image file analyzing section 509 determines that positional information is added to the image file (Yes, in S103), the display control section 507 causes the display section 40 to display an image operation menu on which a “Security” button is displayed together with buttons such as an “Edit” button and a “Wall paper registration” button. (b) of FIG. 5 is a view illustrating an example of the image operation menu including the “Security” button.

On the other hand, in a case where the image file analyzing section 509 determines that no positional information is added to the image file (No, in S103), the display control section 507 causes the display section 40 to display a normal image operation menu (S104).

The normal image operation menu is a menu displayed after one image displayed on the image list screen is pressed and held in a normal case (a case where no positional information is added to the image data). Specifically, buttons such as an “Edit” button and a “Wall paper registration” button are displayed on the normal image operation menu, whereas a “Security” button is not displayed on the normal image operation menu. Even in a case where the “Security” button is displayed, the “Security” button is displayed in gray or the like, and cannot be selected. Note that since the normal image operation menu and a process carried out after the normal image operation menu is displayed are not concerned with the feature of the present invention, the normal image operation menu is not illustrated, and the process carried out after the normal image operation menu is displayed is not described here.

Next, in a case where the “Security” button is selected on the image operation menu including the “Security” button, the operation obtaining section 508 detects an input of “selection of security” (S106). Then, the operation obtaining section 508 notifies the image file analyzing section 509 of such detection.

Then, in a case where the image file analyzing section 509 receives such notification from the operation obtaining section 508, with reference to the management table illustrated in (a) of FIG. 3, the image file analyzing section 509 causes, in accordance with the “file name” of the image selected, a security level and an effective area which are associated with the “file name” of the image to be displayed (S107). For example, in a case where the management table illustrated in (a) of FIG. 3 does not include the image, “No” is displayed, as a default value, for the security level and the effective area (S107). (c) of FIG. 5, is a view illustrating an example of display in which the current security setting of the image is the default value.

Next, the operation obtaining section 508 obtains, from the input section 30, a “Security Level” (e.g., high, middle, low, and the like) inputted by the user (S108). (d) of FIG. 5 is a view illustrating an example of a setting screen of the “Security Level”.

Subsequently, the operation obtaining section 508 obtains, from the input section 30, an “Effective Area” (security area) (e.g., 20 m, 100 m, 1000 m, and the like in radius) inputted by the user (S109). (e) of FIG. 5 is a view illustrating an example of a selection screen of the “Effective Area” (security area).

Subsequently, the operation obtaining section 508 receives an instruction signal generated by the input section 30 (S110). In a case where the operation obtaining section 508 receives a “Cancel” signal from the input section 30 (No, in S110), the screen which displays a current security state of the image is returned (S107; see (c) of FIG. 5).

On the other hand, in a case where the operation obtaining section 508 receives an “OK” signal from the input section 30 (Yes, in S110; see (f) of FIG. 5), the operation obtaining section 508 supplies, to the security setting section 510, the “Security Level”, the “Effective Area”, each of which has been inputted by the user, and the file name of the image selected.

Then, in accordance with information thus received from the operation obtaining section 508, the security setting section 510 stores, in the management table illustrated in (a) of FIG. 3, security setting information in which the “Security Level” and the “Effective Area” are associated with the “file name” of the image (S111). (g) of FIG. 5 is a view illustrating an example of a screen displayed in a case where the information received from the operation obtaining section 508 is stored in the management table illustrated in (a) of FIG. 3.

(Flow of Switching Security Function)

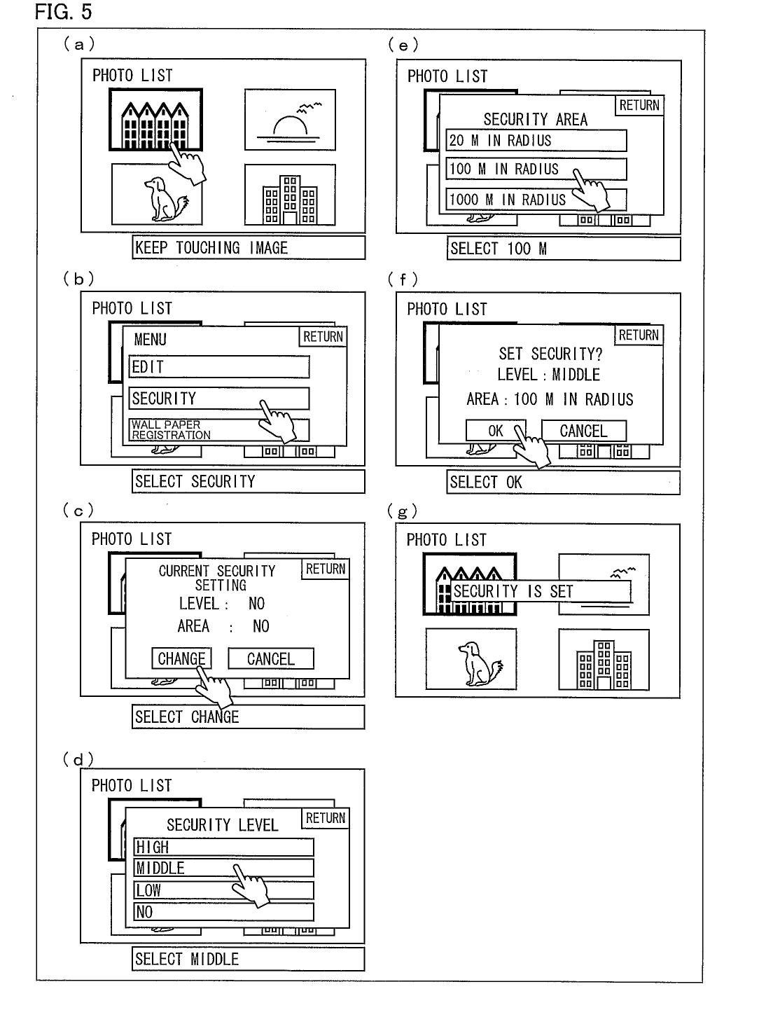

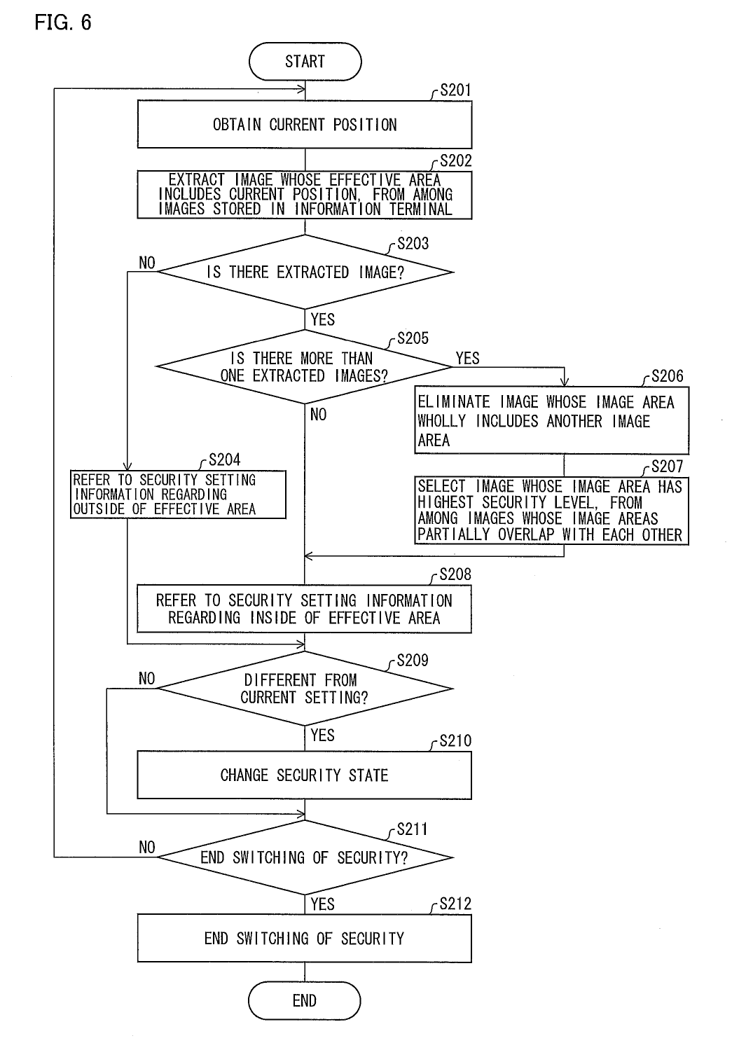

The following description will discuss, with reference to FIG. 6, how the mobile phone 1 switches the security function. FIG. 6 is a flowchart illustrating an example of how the mobile phones 1 and 5 each switch over the security function.

First, the positional information obtaining section 501 obtains a current position from the GPS 10 (see FIG. 6) (S201).

Subsequently, the image file extracting section 502 searches images stored in the storing section 20, and extracts an image whose effective area (see (a) of FIG. 3), which is associated with the image, includes the current position obtained by the positional information obtaining section 501 (S202).

Next, the image file extracting section 502 determines whether or not there is an extracted image(s) (S203).

In a case where the image file extracting section 502 determines that there is an extracted image (Yes, in S203), the image file extracting section 502 determines whether or not there is more than one extracted image (S205).

In a case where the image file extracting section 502 determines that the extracted images are plural (Yes, in S205), the image file selecting section 503 selects an image having the highest priority among the plural extracted images.

Here, the following description will discuss, with reference to FIG. 7, a method for determining a priority of an image according to the present embodiment. FIG. 7 is a view illustrating a basic pattern observed in a case where there are a plurality of images whose effective areas each include a current position. Circular areas illustrated in FIG. 7 each indicate an effective area associated with an image. Further, a shaded area indicates a part in which the effective area overlaps with the other effective area. (a) of FIG. 7 is a view illustrating an example in which an effective area associated with one of extracted images wholly overlaps with an effective area associated with the other of the extracted images (i.e., the effective area is completely included in the other effective area). (b) of FIG. 7 is a view illustrating an example in which an effective area associated with one of extracted images partially overlaps with an effective area associated with the other of the extracted images.

The method for determining a priority of an image of the present embodiment is as follows. First, in a case where the effective area completely overlaps with the other effective area associated with the extracted image (see (a) of FIG. 7), security setting information associated with an image having an innermost effective area becomes effective. Further, in a case where (i) there are a plurality of effective areas each of which is an innermost effective area and (ii) the plurality of effective areas partially overlap with each other (see (b) of FIG. 7), security setting information associated with an image whose effective area has the highest security level, among the plurality of effective areas, becomes effective.

Note that a method for determining the priority of the image is not particularly limited. It is only necessary that (i) one image is selected and (ii) security setting information on the one image can be specified. For example, an image having the highest security level or an image having the lowest security level can be always selected.

First, in accordance with the method for determining an priority of an image, the image file selecting section 503 selects, according to the pattern illustrated in (a) of FIG. 7, an image having an innermost effective area (S206). Subsequently, the image file selecting section 503 selects, according to the pattern illustrated in (b) of FIG. 7, an image whose effective area has the highest security level (S207). According to this, one image is selected.

Specifically, for example, according to the pattern illustrated in (a) of FIG. 7, the image file selecting section 503 selects an image or a plurality of images each having an innermost effective area. As a result, one image or a plurality of images whose effective areas partially overlap with each other is/are selected. In a case where one image is selected, the step S207 can be omitted. In a case where a plurality of images are selected, however, the image file selecting section 503 then selects, according to the pattern illustrated in (b) of FIG. 7, an image whose effective area has the highest security level. As a result, one image is selected.

Then, the setting information specifying section 504 specifies, in accordance with the management table illustrated in (a) of FIG. 3, a security level to be set (S208).

On the other hand, in a case where the image file extracting section 502 determines that there is not more than one extracted image (i.e., there is only one extracted image) (No, in S205), the setting information specifying section 504 specifies, in accordance with the management table illustrated in (a) of FIG. 3, a security level to be set (S208).

Moreover, in a case where the image file extracting section 502 determines that there is no extracted image file (No, in S203), the setting information specifying section 504 specifies a security level to be set, with reference to security setting information on the outside of the effective area (i.e., there is no image whose effective area includes the current position, that is, no current position is included in any of effective areas each associated with an image) (S204). Note that, according to the present embodiment, since the security level in the outside of the effective area is always “high”, the security level to be set is specified to be “high”.

After the setting information specifying section 504 specifies the security level to be set, the setting information specifying section 504 notifies the security function control section 506 of the security level thus specified.

Next, the current setting information obtaining section 505 obtains current security setting information from the storing section 20, and notifies the security function control section 506 of the current security setting information thus obtained.

Then, the security function control section 506 compares the security level to be set, which security level has been notified by the setting information specifying section 504, with a current security level indicated by the current security setting information, which has been notified by the current setting information obtaining section 505 (S209).

In a case where the security function control section 506 determines, as a result of the comparison, that the security level to be set is “different” from the current security level (Yes, in S209), the security function control section 506 changes a security state to the security level to be set (S210). Then, the security function control section 506 stores, in the storing section 20, the security level newly set, so that the current security setting information is updated with the security level newly set. Thereafter, the control section 50 determines whether or not to end the process of switching the security function (S211).

On the other hand, in a case where the security function control section 506 determines, as a result of the comparison, that the security level to be set is “identical” to the current security level (No, in S209), the control section 50 determines whether or not to end the process of switching the security function (S211).

In a case where the control section 50 determines to end the process of switching the security function (Yes, in S211), the control section 50 ends the process of switching the security function (S212). On the other hand, in a case where the control section 50 determines not to end the process of switching the security function (No, in S211), the positional information obtaining section 501 repeats obtaining a current position from the GPS (S201).

### Second Embodiment

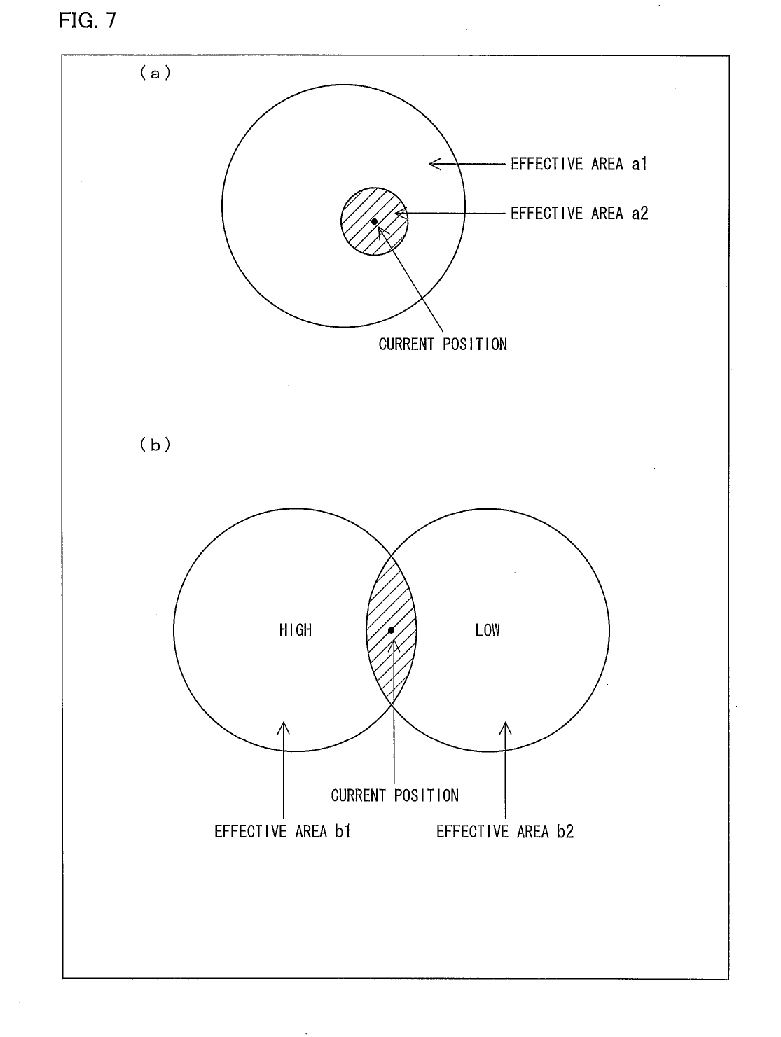

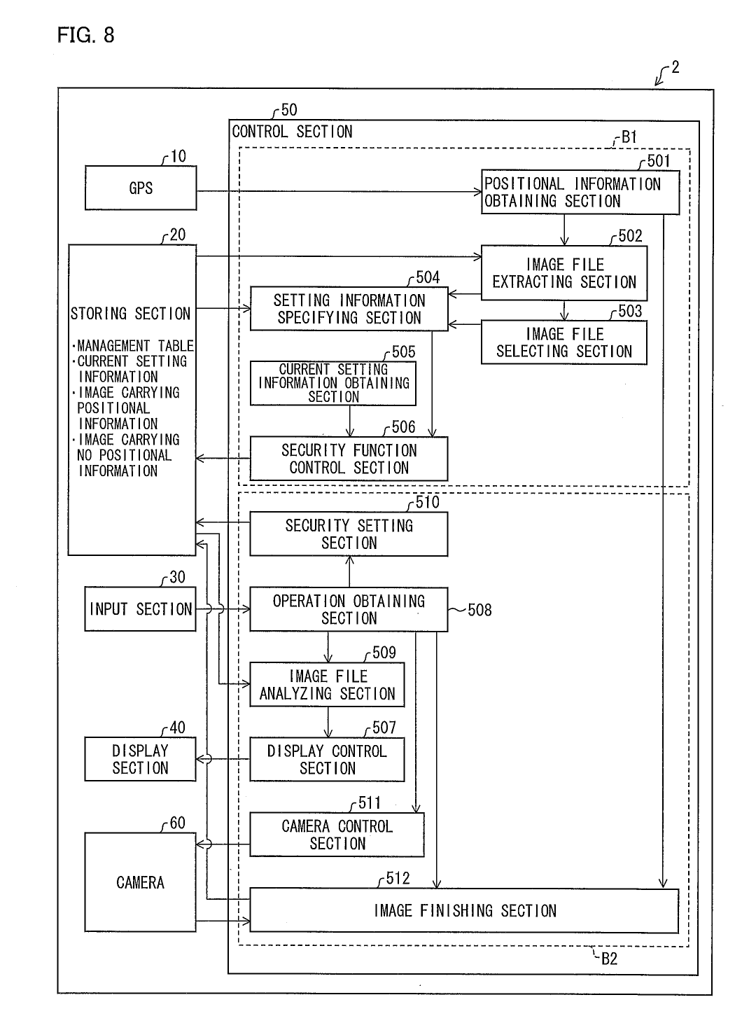

First Embodiment has discussed an example in which the mobile phone 1 is configured such that the security setting is carried out on the image list screen. As Second Embodiment, the following description will specifically discuss, with reference to FIGS. 8 through 10, an example in which a mobile phone 2 (information terminal) is configured such that the security setting is simultaneously carried out at a time when a camera captures an image.

Note that components identical to those described in First Embodiment are given identical reference numbers, and are not described repeatedly here. Note that differences of Second Embodiment from First Embodiment will be mainly discussed here. Components which are not particularly described here have configurations and functions identical to those described in First Embodiment.

(Main Part of Configuration of Mobile Phone)

The following description will discuss a configuration of the mobile phone 2 of the present embodiment with reference to FIG. 8. FIG. 8 is a block diagram illustrating a main part of a configuration of the mobile phone 2.

The mobile phone 2 has a configuration identical to that of the mobile phone 1 illustrated in FIG. 1, except that the mobile phone 2 further includes a camera 60, a camera control section 511 (imaging means) as a block B2 of a control section 50, and an image finishing section 512 (image data generating mean) (see FIG. 8).

The camera 60 is configured to capture an image such as a photograph.

The camera control section 511 activates the camera 60, and controls the camera 60 to perform image capturing.

The image finishing section 512 finishes an image captured by the camera 60 so that the image carries positional information or no positional information. Note here that a positional information obtaining section 501 controls a GPS 10 to obtain the positional information at a time when, right before, or right after the camera 60 captures the image.

(Flow of Security Setting)

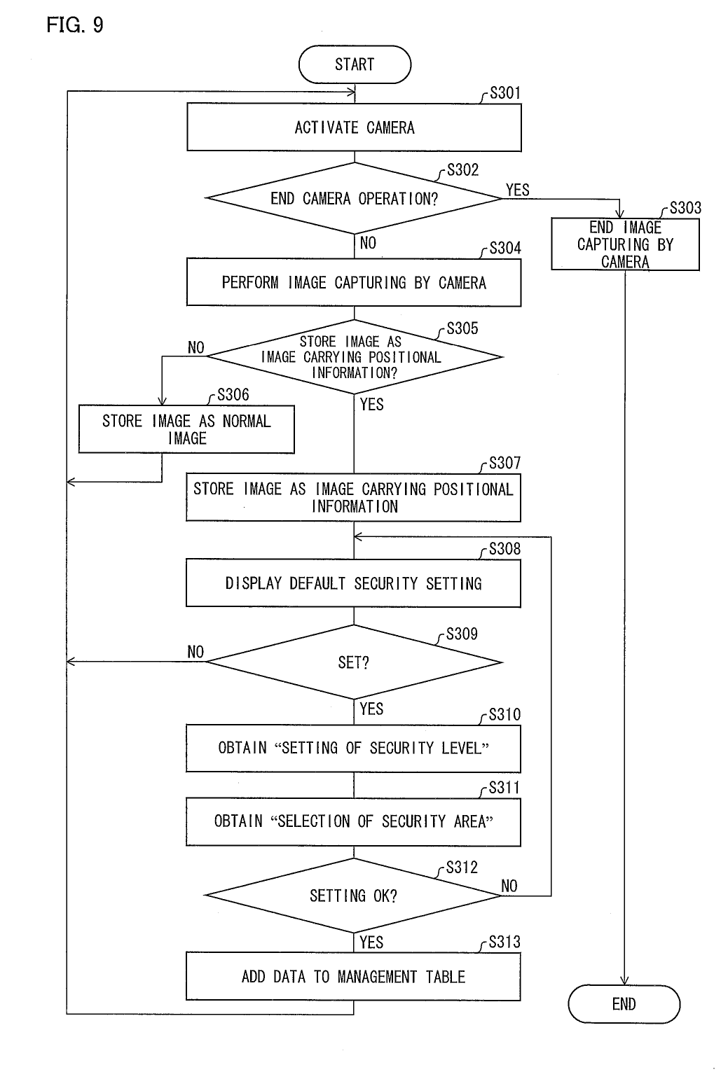

The following description will discuss how the mobile phone 2 carries out the security setting with reference to FIGS. 9 and 10. FIG. 9 is a flowchart illustrating an example of how the mobile phone 2 carries out the security setting. FIG. 10 is a screen transition diagram illustrating an example of how the mobile phones 2 and 6 each carry out the security setting.

First, the camera control section 511 activates an image capturing process, and causes a display section 40 to display a screen which can be captured (see FIG. 9) (S301). (a) of FIG. 10 is a view illustrating an example of a screen displayed after the image capturing process is activated.

Then, in a case where a clear key or the like is pressed or in a case where the image capturing process times out, the camera control section 511 determines whether or not to end the image capturing process (S302). In a case where the camera control section 511 determines to end the image capturing process (Yes, in S302), the camera control section 511 ends the image capturing process (S303).

On the other hand, in a case where (i) the camera control section 511 determines not to end the image capturing process (No, in S302) and (ii) the operation obtaining section 508 receives a capturing instruction signal from a user (in a case where the operation obtaining section 508 detects that the user has pressed a shutter), the operation obtaining section 508 notifies the camera control section 511 of the receipt of the capturing instruction signal. Then, in a case where the camera control section 511 receives the notification from the operation obtaining section 508, the camera control section 511 causes the camera 60 to capture an image (S304).

Subsequently, the image finishing section 512 determines whether or not to store, as an image carrying positional information, the image captured by the camera (S305). (b) of FIG. 10 is a view illustrating an example of a screen displayed after the image is captured by the camera.

In a case where the image finishing section 512 determines not to store the image captured as the image carrying positional information (No, in S305), the image finishing section 512 stores, as a normal image (an image carrying no positional information), in the storing section 20, the image captured (S306). Thereafter, the display control section 507 causes the display section 40 to display a screen which can be captured after the camera is activated (see (h) of FIG. 10) (S301).

On the other hand, in a case where the image finishing section 512 determines to store the image captured as the image carrying positional information (Yes, in S305), the image finishing section 512 obtains a current position from the positional information obtaining section 501, then adds the current position to the image captured, and stores, in the storing section 20, the image captured (S307).

Next, the display control section 507 causes the display section 40 to display default security setting information (S308). The default security setting information is information in which the security level and the effective area are each set to “No”. That is, no security level is set in the default security setting information. (c) of FIG. 10 is a view illustrating a screen on which the default security setting information is displayed.

Next, the operation obtaining section 508 determines whether or not the user has selected a “Setting” button (see (c) of FIG. 10) (S309).

In a case where the operation obtaining section 508 detects that the user has selected a “Cancel” button (see (c) of FIG. 10) (i.e., the user has not selected the “Setting” button) (No, in S309), the display control section 507 causes the display section 40 to display a screen which can be captured after the camera is activated (see (h) of FIG. 10) (S301).

On the other hand, in a case where the operation obtaining section 508 detects that the user has selected the “Setting” button (Yes, in S309), the operation obtaining section 508 then obtains, from an input section 30, a “Security Level” (e.g., high, middle, low, and the like) inputted by the user (S310). (d) of FIG. 10 is a view illustrating an example of a setting screen of the “Security Level”.

Then, the operation obtaining section 508 obtains, from the input section 30, an “Effective Area” (security area) (e.g., 20 m, 100 m, 1000 m, and the like in radius) inputted by the user (S311). (e) of FIG. 10 is a view illustrating an example of a selection screen of the “Effective Area” (security area).

Subsequently, the operation obtaining section 508 determines a type of a user input signal supplied from the input section 30 (S312). In a case where the operation obtaining section 508 receives a “Cancel” signal from the input section 30 (No, in S312), the screen returns to a screen on which the default security setting information is displayed (S308; see (c) of FIG. 10).

On the other hand, in a case where the operation obtaining section 508 receives an “OK” signal from the input section 30 (Yes, in S312; see (f) of FIG. 10), the operation obtaining section 508 transmits, to the security setting section 510, the “Security Level”, the “Effective Area”, and a file name of the image selected.

Then, the security setting section 510 stores, in accordance with the information received from the operation obtaining section 508, security setting information in the management table illustrated in (a) of FIG. 3 (S313). (g) of FIG. 10 is a view illustrating an example of a screen displayed in a case where the information received from the operation obtaining section 508 is stored in the management table illustrated in (a) of FIG. 3.

Thereafter, the display control section 507 causes the display section 40 to display a screen which can be captured after the camera is activated (see (h) of FIG. 10) (S301).

### Third Embodiment

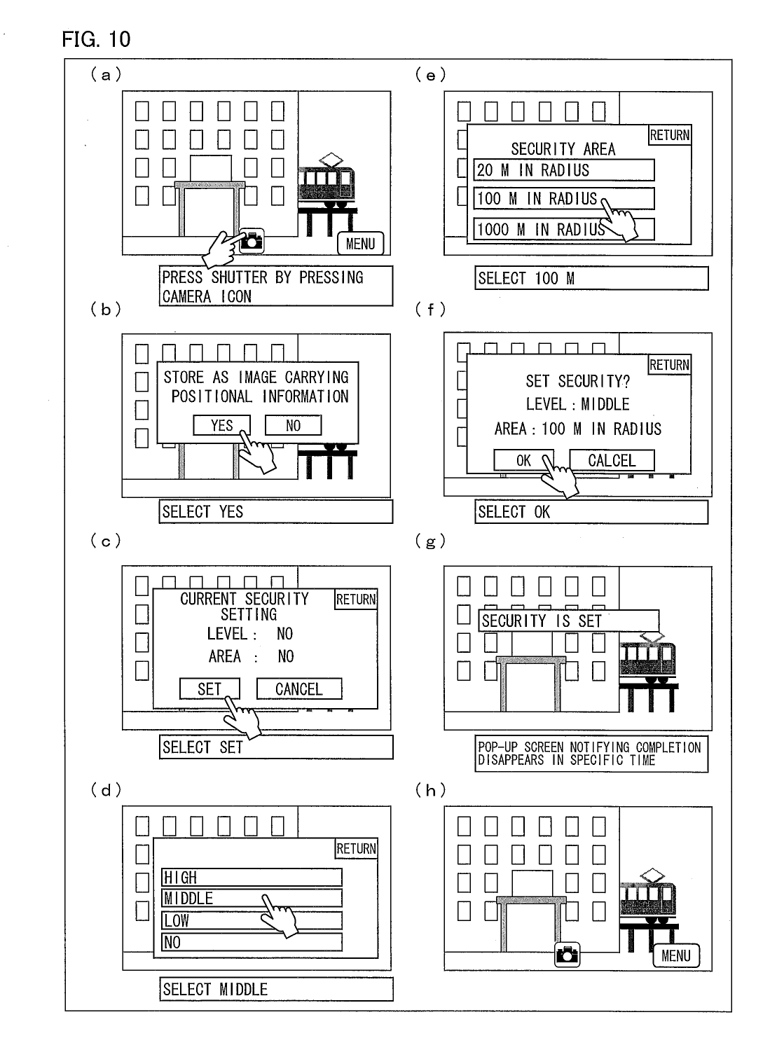

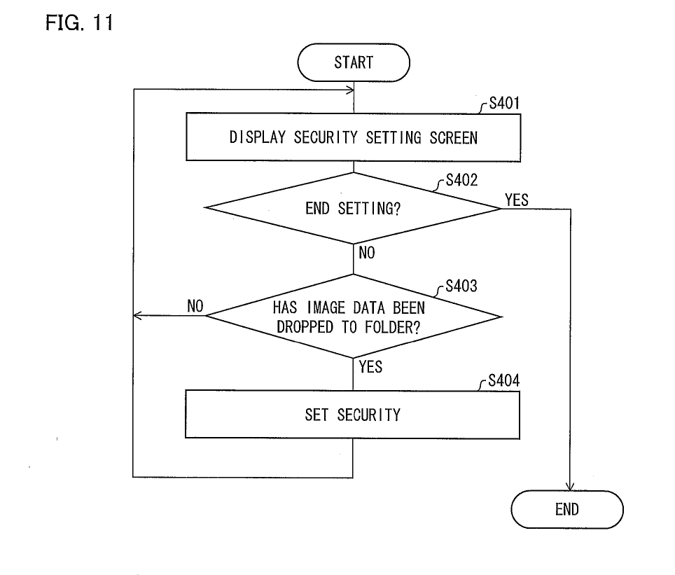

First and Second Embodiments have discussed the respective mobile phones 1 and 2 are configured such that the security level and the effective area are selected by the user, and the security setting is carried out. With reference to FIGS. 11 through 14, the following description will specifically discuss, as Third Embodiment, an example in which a mobile phone 3 (information terminal) is configured such that (i) a setting folder constituted by a combination of the security level and the effective area is prepared in advance and (ii) security setting is carried out by dropping an image file to the setting folder.

Note that components identical to those described in First Embodiment are given identical reference numbers, and are not described repeatedly here. Note that differences of Third Embodiment from First Embodiment will be mainly discussed here. Components which are not particularly described here have configurations and functions identical to those described in First Embodiment.

(Main Part of Configuration of Mobile Phone)

The mobile phone 3 has a configuration identical to that of the mobile phone 1 illustrated in FIG. 1, except that, in regard to the management table stored in the storing section 20, the mobile phone 3 does not have the management table illustrated in (a) of FIG. 3. Therefore, the configuration of the mobile phone 3 is not described repeatedly here. That is, according to the present embodiment, the setting folder is used instead of the management table illustrated in (a) of FIG. 3.

(Flow of Security Setting)

The following description will discuss how the mobile phone 3 carries out the security setting, with reference to FIGS. 11 and 12. FIG. 11 is a flowchart illustrating an example of how the mobile phones 3 and 7 each carry out the security setting. FIG. 12 is a screen transition diagram illustrating an example of how the mobile phones 3 and 7 each carry out the security setting.

First, a display control section 507 makes a list of setting folders and a list of image files stored in the mobile phone 3, and controls a display section 40 to display those lists as a security setting screen (see FIG. 11) (S401). (a) of FIG. 12 is a view illustrating an example of the security setting screen displayed on the display section 40.

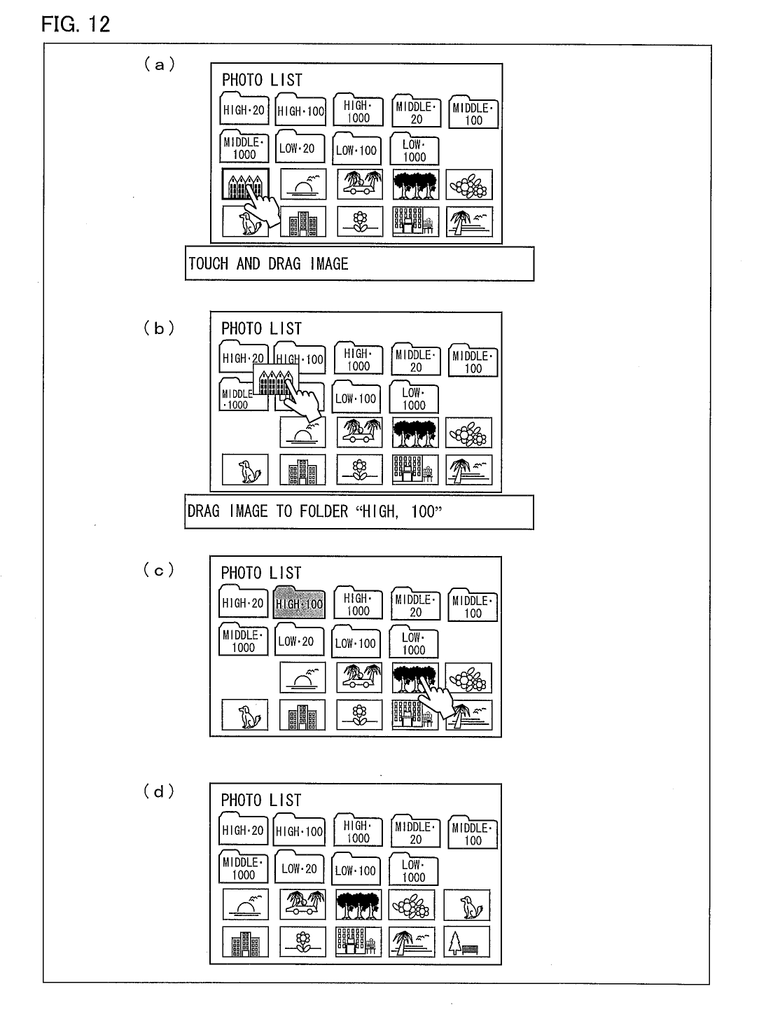

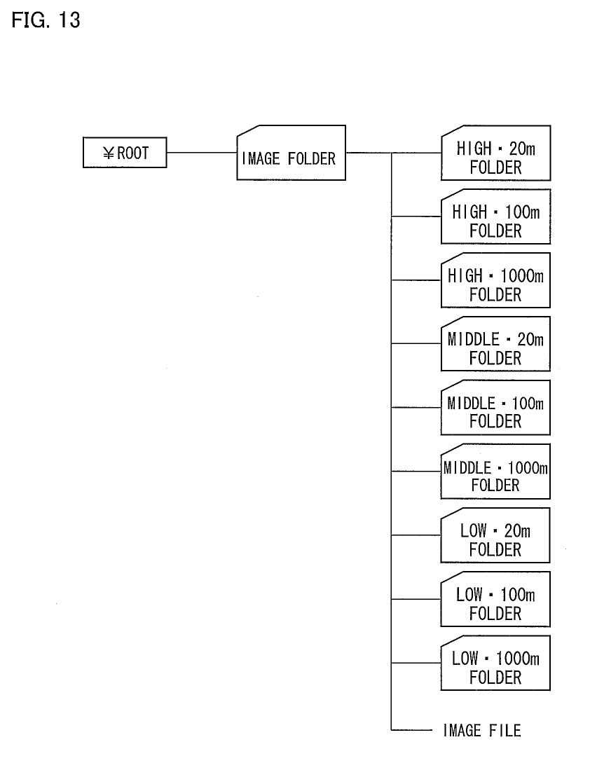

The following description will discuss the setting folders with reference to FIG. 13. FIG. 13 is a tree chart illustrating a relationship between the setting folders and the image files. According to the present embodiment, the setting folders are present together with the image files under an image folder. The security setting is carried out by moving, to one of the setting folders, an image file carrying positional information among the image files.

Note here that a security state of an image file present under each of the setting folders is not determined by the image file itself but is determined by a setting folder under which the image file is present. For example, an image file present under a setting folder “high, 20 m” is an image file whose security level is set to “high” in an effective area within a “20-meter” radius from a place indicated by positional information added to the image file.

Moreover, on an operation screen, an image file carrying no positional information can be controlled not to be dropped to a setting folder or can be controlled not to be displayed on the security setting screen. Alternatively, an image file carrying positional information and a normal image file carrying no positional information can be simply displayed so that the image file carrying positional information and the normal image file carrying no positional information can be distinguished from each other.

Next, an operation obtaining section 508 determines whether or not to end the security setting in a case where it is detected that a clear key or the like is pressed (S402). In a case where the operation obtaining section 508 determines to end the security setting (Yes, in S402), a control section 50 ends displaying the security setting screen.

On the other hand, in a case where the operation obtaining section 508 determines not to end the security setting (No, in S402), the operation obtaining section 508 determines whether or not an image file carrying positional information has been dropped to one of the setting folders (S403).

In a case where the operation obtaining section 508 determines that no image file carrying positional information has been dropped to any of the setting folders (No, in S403), a display control section 507 controls the display section 40 to continue to display the security setting screen (S401).

On the other hand, in a case where the operation obtaining section 508 determines that the image file carrying positional information has been dropped to one of the setting folders (see (b) of FIG. 10) (Yes, in S403), a security setting section 510 carries out the security setting by moving the image file carrying positional information to the one of the setting folders (see (c) of FIG. 10) (S404).

Thereafter, the display control section 507 controls the display section 40 to continue to display the security setting screen (see (d) of FIG. 10) (S401).

(Flow of Switching Security Function)

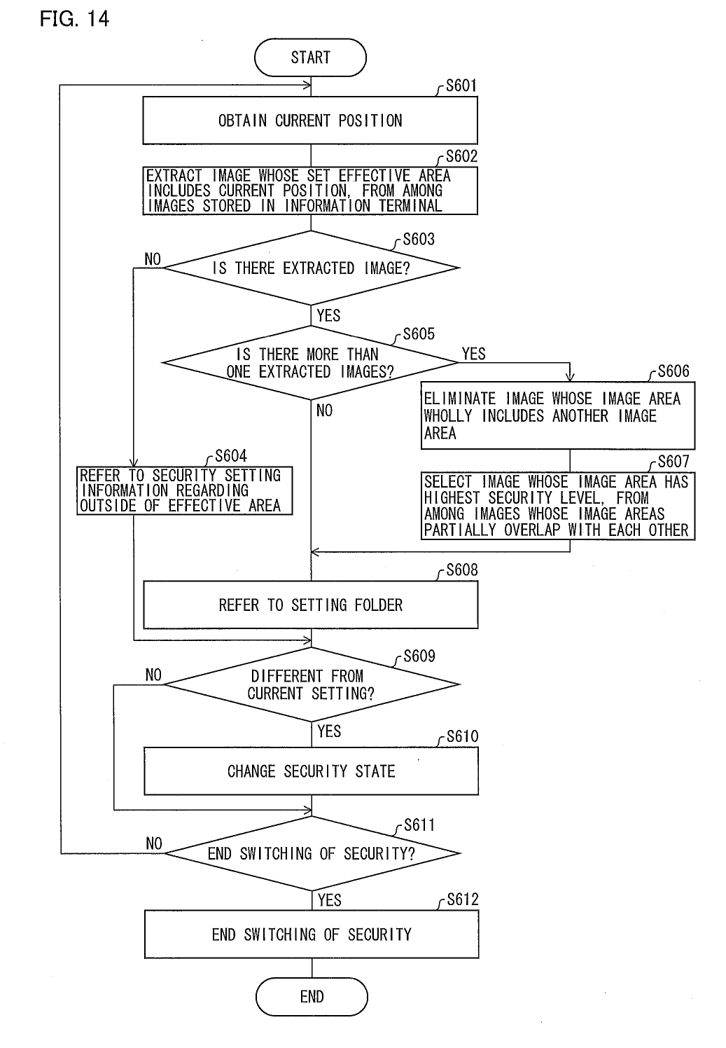

The following description will discuss, with reference to FIG. 14, how the mobile phone 3 switches security function. FIG. 14 is a flowchart illustrating an example of how the mobile phones 3 and 7 each switch over the security function.

First, the positional information obtaining section 501 obtains a current position from the GPS 10 (see FIG. 14) (S601).

Subsequently, the image file extracting section 502 searches images present each of the setting folders, and extracts an image whose effective area derived from a setting folder under which the image is present includes the current position obtained by the positional information obtaining section 501 (S602).

Next, the image file extracting section 502 determines whether or not there is an extracted image(s) (S603).

In a case where the image file extracting section 502 determines that there is no extracted image (No, in S603), a setting information specifying section 504 specifies, with reference to security setting information on outside of the effective area, a security level to be set (S604). In the present embodiment, the security level in the outside of the effective area is always specified to be “high”.

On the other hand, in a case where the image file extracting section 502 determines that there is an extracted image (Yes, in S603), the image file extracting section 502 then determines whether or not there is more than one extracted image (S605).

In a case where the image file extracting section 502 determines that the extracted images are plural (i.e., there is more than one extracted image) (Yes, in S605), the image file selecting section 503 selects an image having the highest priority, among the plural extracted images, in accordance with the method for determining a priority of an image described in First Embodiment with reference to FIG. 7. Specifically, first, the image file selecting section 503 selects, according to the pattern illustrated in (a) of FIG. 7, an image having an innermost effective area (S606). Subsequently, according to the pattern illustrated in (b) of FIG. 7, the image file selecting section 503 selects an image whose effective area has the highest security level (S607). According to this, one image is selected.

Then, the setting information specifying section 504 specifies, in accordance with a folder name of a setting folder including the one image thus selected, a security level to be set (S608).

On the other hand, in a case where the image file extracting section 502 determines that there is not more than one extracted image (i.e., there is only one extracted image) (No, in S605), the setting information specifying section 504 specifies, in accordance with the folder name of the setting folder including the one image thus extracted, a security level to be set (S608).

After the setting information specifying section 504 specifies the security level to be set, the setting information specifying section 504 notifies a security function control section 506 of the security level thus specified.

Next, the current setting information obtaining section 505 obtains current security setting information from the storing section 20, and notifies the security function control section 506 of the current security setting information thus obtained.

Then, the security function control section 506 compares the security level to be set, which security level has been notified by the setting information specifying section 504, with a current security level indicated by the current security setting information, which has been notified by the current setting information obtaining section 505 (S609).

In a case where the security function control section 506 determines, as a result of the comparison, that the security level to be set is “different” from the current security level (Yes, in S609), the security function control section 506 changes a security state to the security level to be set (S610). Then, the security function control section 506 stores, in the storing section 20, the security level newly set, so that the current security setting information is updated with the security level newly set. The control section 50 then determines whether or not to end the process of switching the security function (S611).

On the other hand, in a case where the security function control section 506 determines, as a result of the comparison, that the security level to be set is “identical” to the current security level (No, in S609), the control section 50 determines whether or not to end the process of switching the security function (S611).

In a case where the control section 50 determines to end the process of switching the security function (Yes, in S611), the control section 50 ends the process of switching the security function (S612). On the other hand, in a case where the control section 50 determines not to end the process of switching the security function (No, in S611), the positional information obtaining section 501 repeats obtaining a current position from the GPS 10 (S601).

Note that the above description has discussed a case where the image file is actually moved to the setting folder along with movement of the image file on the screen. However, it is possible, instead of actually moving the image file to the setting folder, to rewrite security setting information (e.g., security level, effective area) stored in the management table to security setting assigned to the setting folder on the screen to which setting folder the image file is moved. This eliminates the need for actually moving the image file, thereby improving a processing speed.

### Fourth Embodiment

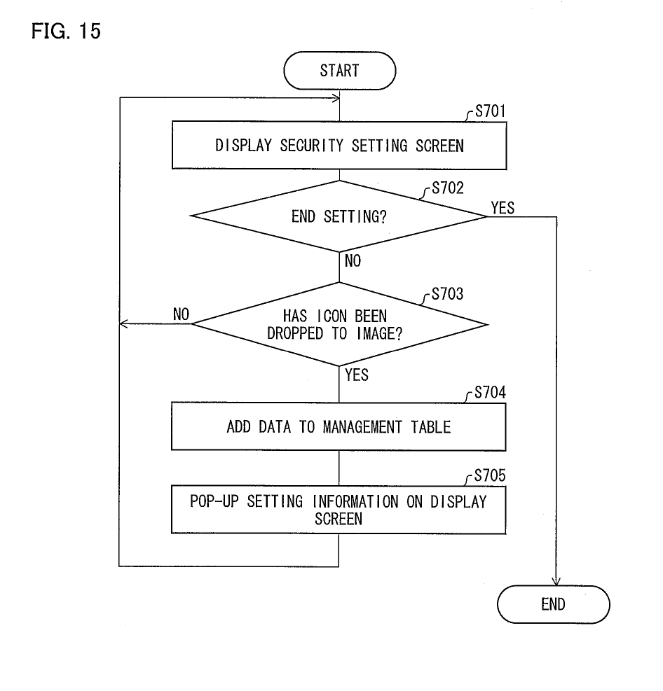

Third Embodiment has discussed an example in which the mobile phone 3 is configured such that security setting is carried out by dropping an image file to a setting folder. However, with reference to FIGS. 15 and 16, the following description will specifically discuss, as Fourth Embodiment, an example in which a mobile phone 4 (information terminal) is configured such that security setting is carried out by dropping, to an image file, an icon which is prepared in advance and which is made up of a combination of a security level and an effective area.

Note that the present embodiment is not limited to such an arrangement that the security setting is carried out by dropping the icon to the image file. For example, the security setting can be carried out by dropping the image file to the icon.

Further, identical reference numbers are assigned to components identical to those described in First Embodiment, and no description of the components will be provided. Fourth Embodiment will mainly discuss differences between Fourth Embodiment and First Embodiment. Components which are not specifically described here have respective configurations and functions identical to those of the components described in First Embodiment.

(Flow of Security Setting)

The following description will discuss, with reference to FIGS. 15 and 16, how the mobile phone 4 carries out the security setting. FIG. 15 is a flowchart illustrating an example of how the mobile phone 4 carries out the security setting. FIG. 16 is a screen transition diagram illustrating an example of how the mobile phones 4 and 8 each carry out the security setting.

First, a display control section 507 makes a list of icons and a list of image files stored in the mobile phone 4, and then controls a display section 40 to display, as a security setting screen, the list of the icons and the list of the image files (S701) (see FIG. 15). (a) of FIG. 16 is a view illustrating an example of the security setting screen displayed on the display section 40. For example, an icon displayed with “high, 100” is an icon with which a security level is set to “high” in an effective area within a “10-meter” radius from a position indicated by positional information added to an image file to which the icon is dropped. As just described, the list of the icons, to which respective security settings are assigned, is displayed on a display screen together with the list of the image files.

Note that an image file carrying no positional information can be displayed in gray and controlled so that an icon cannot be dropped to the image file. Alternatively, the image file carrying no positional information can be controlled not to be displayed on the security setting screen. Further, an image file carrying positional information and a normal image file carrying no positional information can be simply displayed so that they can be distinguished from each other.

Next, an operation obtaining section 508 determines whether or not to end the security setting in a case where a clear key or the like is pressed (S702). In a case where the operation obtaining section 508 determines to end the security setting (Yes, in S702), a control section 50 ends display of the security setting screen.

On the other hand, in a case where the operation obtaining section 508 determines not to end the security setting (No, in S702), the operation obtaining section 508 determines whether or not an icon has been dropped to an image file carrying positional information (S703).

In a case where the operation obtaining section 508 determines that the icon has not been dropped to the image file carrying positional information (No, in S703), the display control section 507 controls the display section 40 to continue to display the security setting screen (S701).

On the other hand, in a case where the operation obtaining section 508 determines that the icon has been dropped to the image file carrying positional information (see (b) of FIG. 16) (Yes, in S703), a security setting section 510 stores, in accordance with security setting information indicated by the icon which has been dropped to the image file, the security setting information on a management table illustrated in (a) of FIG. 3 (S704).

Next, the display control section 507 controls the display section 40 to pop up, on the security setting screen, the security setting information thus stored (see (c) of FIG. 16) (S705).

Thereafter, the display control section 507 controls the display section 40 to continue to display the security setting screen (see (a) of FIG. 16) (S701).

### Fifth Embodiment

The following description will discuss further another embodiment of the present invention with reference to FIGS. 2 to 7 and FIGS. 17 to 19. According to the present embodiment, a security setting section 510 associates security information with an image file by (i) adding the security setting information to the image file and (ii) storing, in a storing section 20, the image file to which the security setting information is added.

Note that, in the following description, identical reference numbers are assigned to components identical to those described in First Embodiment.

(Outline of Process)

The following description will discuss, with reference to FIG. 2, an outline of a process carried out in the present embodiment. FIG. 2 is a view illustrating an example of an outline of a process carried out in the plurality of embodiments including the present embodiment. FIG. 2 illustrates an example in which security management is carried out by separating positions by a workplace and a place other than the workplace. (a) of FIG. 2 is a view illustrating a situation in which an image file of an image captured by a camera is stored together with positional information. (b) of FIG. 2 is a view illustrating a situation in which a security level is changed in accordance with the positional information.

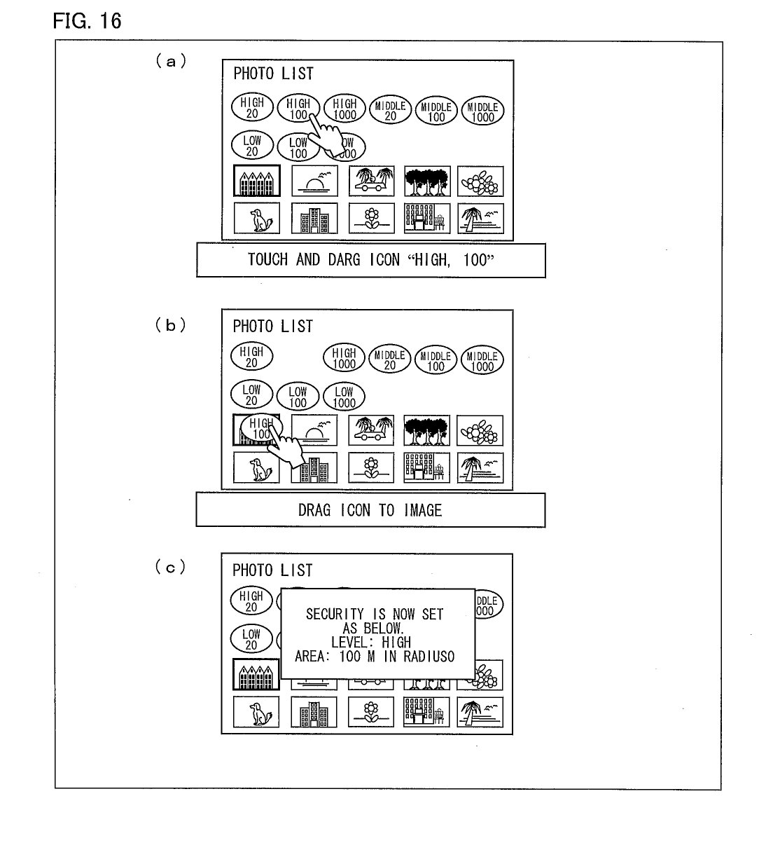

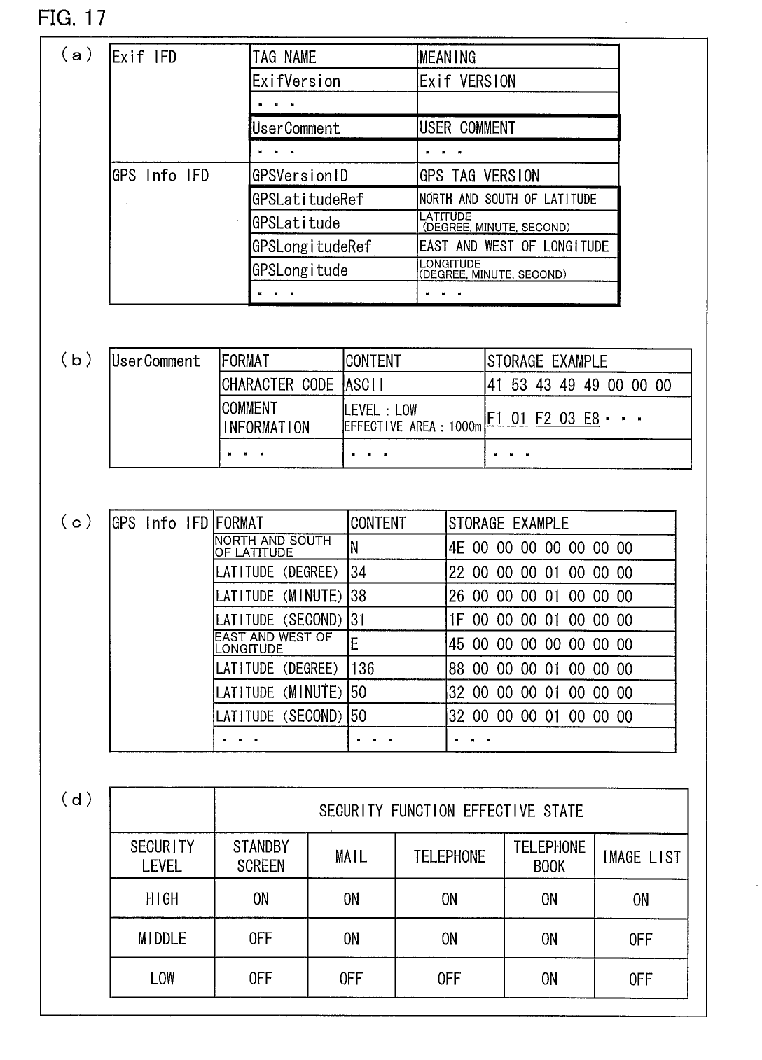

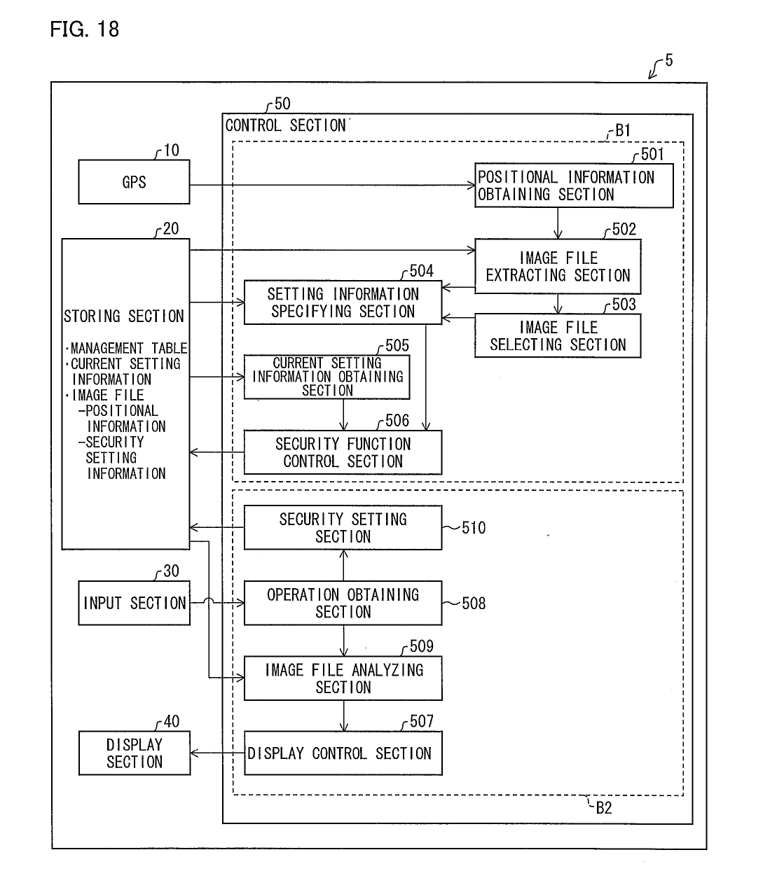

First, a user captures an image of his/her workplace with a camera (see (a) of FIG. 2). After the user captures the image, a mobile phone 5 (information terminal: see FIG. 18) adds, to an image file of the image thus captured, positional information indicative of a place at which the image has been captured (that is, positional information on a place near the workplace), and stores the image file to which the positional information is added.

Thereafter, the mobile phone 5 carries out security setting.

Note that the present embodiment will discuss, for example, a case where security setting information added to such an image file carrying positional information is arranged such that a security level indicates “low” and an effective area indicates “20 m” (that is, 20 meters) (a specific setting method will be described later). In this case, the mobile phone 5 carries out the security management so that the security level is set to “low” in an area within a 20-meter radius from the place indicated by the positional information which is added to the image file and so that the security level is set to “high” in outside of the above area.

Then, as illustrated in (b) of FIG. 2, in a case where the user having the mobile phone 5 is at the workplace (that is, in a case where the user having the mobile phone 5 is in the area within a 20-meter radius from the place indicated by the positional information which is added to the image file of the image), the mobile phone 5 automatically sets the security level to “low”. In a case where the user is at a place other than the workplace (that is, in a case where the user is in the outside of the above area), the mobile phone 5 automatically set the security level to “high”.

Next, the following description will discuss the security level and the effective area with reference to FIG. 17. FIG. 17 is a view illustrating examples of an Exif information area and a security function effective state management table of an image file, the Exif information area and the security function effective state management table each storing setting information on a security function.

According to the present embodiment, the security level and the effective area are stored in a user comment region (UserComment) of an Exif block (Exif IFD) of the Exif information (hereinafter, for the sake of simple explanation, a region in which the security level and the effective area are stored is referred to as a security setting information area). Further, the positional information is stored in a GPS information block (GPS Info IFD) of the Exif information (hereinafter, for the sake of simple explanation, a region in which the positional information is stored is referred to as a positional information area). Further, an effective state of the security function, which effective state depends on each security level, is stored in the security function effective state management table (see (d) of FIG. 17).

(a) of FIG. 17 is a view illustrating an example of a format of the Exif block and the GPS information block of the Exif information of the image file. (b) of FIG. 17 is a view illustrating an example in which the security level and the effective area are stored in the user comment region. (c) of FIG. 17 is a view illustrating an example in which the positional information is stored in the GPS information block. (d) of FIG. 7 is a view illustrating an example of the security function effective state management table indicative of the effective state of the security function, which effective state depends on each security level.

First, the following description will discuss, with reference to (b) of FIG. 17, how to store the security level and the effective area in the user comment region (UserComment) in the format illustrated in (a) of FIG. 17.

As illustrated in (b) of FIG. 17, in the first eight bytes of the user comment region, a character code (ASCII code in the present embodiment) is stored. In the next two bytes of the user comment region, the security level is stored. In the further next three bytes of the user comment region, the effective area is stored. Specifically, a specific code (0xF1 in the present embodiment) indicative of a beginning of a code regarding the security level is stored in the first one of the two bytes for the security level, and a value indicative of a level (for example, 0x01 indicates a low level, 0x02 indicates a middle level, and 0x03 indicates a high level, in the present embodiment) is stored in the second one of the two bytes for the security level.

Further, a specific code (0xF2 in the present embodiment) indicative of a beginning of a code regarding the effective area is stored in the first one of the three bytes for the effective area, and a specific value of the effective area (0x03E8 indicative of 1000 m, in the present embodiment) is stored in the second and third ones of the three bytes for the effective area.

The following will discuss, with reference to Fig. (c) of FIG. 17, how to store the positional information in the GPS information block (GPS Info IFD) in the format illustrated in (a) of FIG. 17.

For example, positional information, indicative of a position at a latitude of 34 degrees, 38 minutes, and 31 seconds north and a longitude of 136 degrees, 50 minutes, and 50 seconds east, is stored as illustrated in (c) of FIG. 17. North and south of the latitude and east and west of the longitude are each stored in a form of the ASCII code, that is, stored as “N”, “S”, “E”, and “W”, respectively. Specific degree, minute, and second are each stored in a hexadecimal form. Alternatively, a specific numerical value of each of the specific degree, minute, and second can be stored in the first four bytes, and a numerical value indicative of a valid byte count of the first four bytes can be stored in the other four bytes.

Note here that (b) and (c) of FIG. 17 each illustrate, as an example of the setting information on the security function, that the security level is set to “low” in the effective area within a “1000-meter” radius from the position at a latitude of 34 degrees, 38 minutes, and 31 seconds north and a longitude of 136 degrees, 50 minutes, and 50 seconds east.

Further, as illustrated in (d) of FIG. 17, it is defined that, in a case where the security level is “low”, the security function is set to OFF with respect to functions other than a “Telephone Book” function and that the security function is set to ON with respect to the “Telephone Book” function. Specifically, in a case where the security level is set to “low”, only the use of the “Telephone Book” function is limited, and the use of the functions other than the “Telephone Book” function (i.e., “Standby screen”, “Mail”, “Telephone”, and “Image List”) is allowed.

It is not limited in particular how to add the positional information to the image file. It is only necessary that the image file and the positional information can be managed in association. As described in the present embodiment, the positional information and the image file can be retained as one single set of data. Alternatively, the positional information and the image file can be retained as individual sets of data. That is, the positional information and the image file can be managed in such a manner that the positional information and the image file are (i) retained as individual sets of data and (ii) associated with each other by use of a table on which the image file and the positional information are managed in association.

Further, according to the present embodiment, the effective state of the security function on the security function effective state management table illustrated in (d) of FIG. 17 can be predetermined one. Alternatively, the effective state can be changed by a user's operation.

Further, according to the present embodiment, the security level is always “high” in outside of the effective area. Note, however, that the security level in the outside of the effective area can be changed by a user's operation.

Furthermore, the outline of the process in accordance with the present embodiment is not limited to that illustrated in FIG. 2.

For example, in regard to the case illustrated in (a) of FIG. 2, an image file, to be used as an image file carrying positional information, is not limited to an image file of an image captured by a camera of the mobile phone 5. Alternatively, an image file transmitted from an external device can be used. Further, positional information is not necessarily added to the image file from the beginning. The positional information can be later added to the image file by use of software, such as Kashmir and AbleCV, which adds positional information to an image file.

Further, in regard to the case illustrated in (b) of FIG. 2, in a case where the security function is managed, the security function for each of a plurality of functions can be switched on/off collectively according to the security level with reference to the security function effective state management table illustrated in (d) of FIG. 17 as described above. Alternatively, the security function can be switched on/off individually for each function (for example, “Mail”, “Telephone”, and the like), depending on whether or not the mobile phone is in the effective area.

(Main Part of Configuration of Mobile Phone)

The following description will discuss, with reference to FIG. 18, a configuration of the mobile phone 5 in accordance with Fifth Embodiment. FIG. 18 is a block diagram illustrating a main part of the configuration of the mobile phone 5.

As illustrated in FIG. 18, the mobile phone 5 includes a GPS 10, a storing section 20, an input section 30, a display section 40, and a control section 50. Note that the mobile phone 1 can include the other members, such as a speaker, a microphone, and a battery. However, such members are not concerned with the feature of the present invention. Therefore, such members are not illustrated in FIG. 18.

The GPS 10 measures a longitude, a latitude, and an altitude of a current position upon receipt of an electric wave transmitted from an artificial satellite. Note that the present embodiment is not limited to a GPS, provided that a current position is specified. For example, a member can be employed which receives a current position from a base station by communicating with the base station.

In the storing section 20, (i) a control program and an OS program which are executed by the control section 50 and (ii) various sets of data which are read out by the control section 50 in a case where the control section 50 carries out various functions of the mobile phone 5 (for example, the security setting, switch of the security function, and the like (described later)) are stored. According to the present embodiment, data, such as an image file, a security function effective state management table (see (d) of FIG. 17), and current setting information, is stored in the storing section 20. The storing section 20 is realized, for example, by a rewritable non-volatile memory such as an EPROM, an EEPROM (registered trademark), and a flash memory. Note that a storing section in which information that is not necessary to be rewritten is stored can be realized by a read-only semiconductor memory (not illustrated), such as a ROM, and can be provided in addition to the storing section 20.

The input section 30 generates an instruction signal upon receipt of a user's operational instruction.

The display section 40 displays an image in accordance with an instruction from the control section 50. It is only necessary that the display section 40 display an image in accordance with the instruction from the control section 50. For example, an LCD (Liquid Crystal Display), an organic EL display, a plasma display, and the like are applicable to the display section 40.

The control section 50 carries out various operations and integrally controls each section of the mobile phone 5, by executing a program which is read out from the storing section 20 to a temporary storing section (not illustrated).

Note that, for the sake of a simple explanation, the control section 50 is illustrated in such a way that a block B1 enclosed by a broken line is a functional block which switches the security function, whereas a block B2 enclosed by another broken line is a functional block which carries out the security setting.

According to the present embodiment, the control section 50 includes, as the block B1, a positional information obtaining section 501 (position obtaining means), an image file extracting section 502, an image file selecting section 503, a setting information specifying section 504, a current setting information obtaining section 505, and a security function control section 506. Further, the control section 50 includes, as the block B2, a display control section 507, an operation obtaining section 508, an image file analyzing section 509, and a security setting section 510 (function limit setting means). Each of those sections (501 to 510) of the control section 50 can be realized in a case where a CPU (i) reads out a program from a storing device realized by a ROM or the like to a temporary storing section realized by a RAM or the like and (ii) executes the program.

The following description will first discuss each section of the block B1.

The positional information obtaining section 501 reads out positional information on a longitude and a latitude obtained by the GPS 10.

The image file extracting section 502 extracts, from image files each carrying positional information which image files are stored in the storing section 20, an image file whose effective area (see (a) of FIG. 17) includes a position indicated by the positional information which has been read out by the positional information obtaining section 501.

In a case where the image file extracting section 502 extracts a plurality of image files, the image file selecting section 503 selects one image file in accordance with a method for selecting an image file in order of priority (described later).

The setting information specifying section 504 (i) specifies a security level in accordance with security setting information added to the one extracted (or selected) image file, and (ii) specifies, in accordance with the security level thus specified, a security function effective state (function limit setting information) of each function with reference to a security function effective state management table as illustrated in (d) of FIG. 17.

The current setting information obtaining section 505 obtains, from the storing section 20, current setting information indicative of a current security level.

The security function control section 506 compares the security level specified by the setting information specifying section 504 with the current security level indicated by the current setting information obtained by the current setting information obtaining section 505. In a case where the security level is different from the current security level, the security function control section 506 changes a security function effective state of each function in accordance with the security level specified by the setting information specifying section 504.

Next, the following description will discuss each section of the block B2.

The display control section 507 generates an image to be displayed on the display section 40, and supplies the image thus generated to the display section 40.

The operation obtaining section 508 obtains an instruction signal generated by the input section 30.

The image file analyzing section 509 analyzes whether or not positional information is added to an image file. In a case where positional information is added to the image file, the image file analyzing section 509 extracts the positional information. Further, the image file analyzing section 509 analyzes whether or not information, such as a security level and an effective area, is added to the image file. In a case where such information is added to the image file, the image file analyzing section 509 extracts the information.

The security setting section 510 adds, to an image file selected by a user, security setting information (security level, effective area) inputted by the user, which security setting information is obtained by the operation obtaining section 508, and stores the security setting information as illustrated in (a) of FIG. 17.

(Flow of Security Setting)

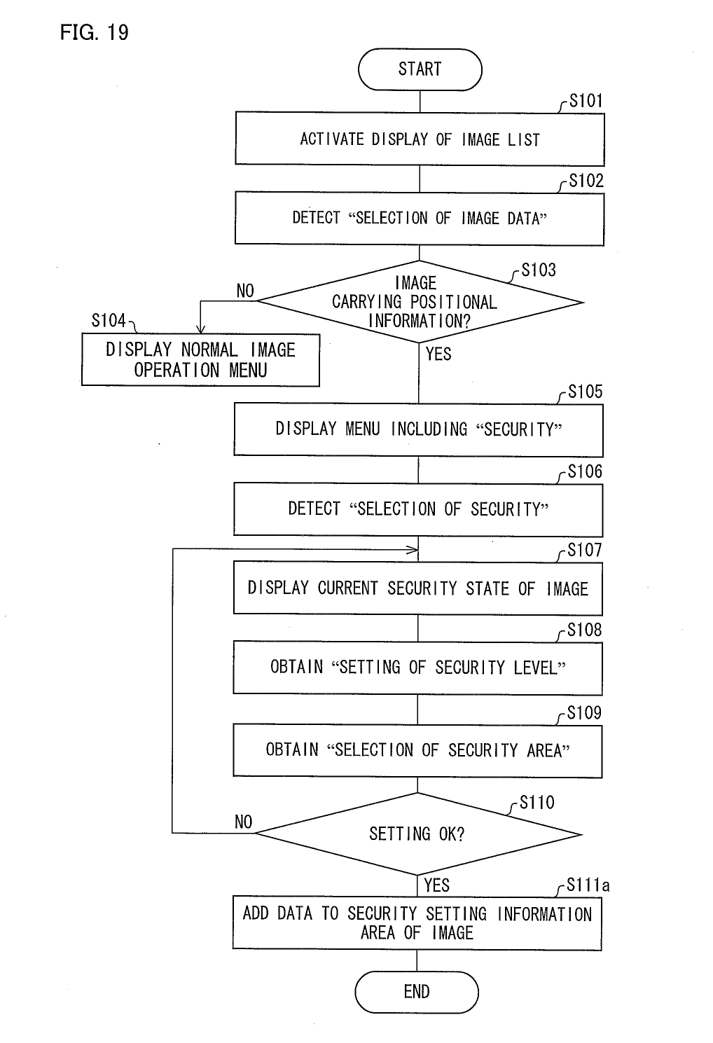

The following description will discuss, with reference to FIGS. 5 and 19, how the mobile phone 5 carries out the security setting. FIG. 19 is a flowchart illustrating an example of how the mobile phone 5 carries out the security setting. FIG. 5 is, as described earlier, a screen transition diagram illustrating an example of how the mobile phones 1 and 5 each carry out the security setting.

First, the display control section 507 makes a list of image files stored in the mobile phone 5, and controls the display section 40 to display the list of the image files (S101) (see FIG. 19). (a) of FIG. 5 is a view illustrating an example of an image file list screen displayed on the display section 40. Note here that the list may include an image file to which no positional information is added.

Next, in a case where an image file is selected by a press-and-hold operation or the like, the operation obtaining section 508 detects an input of “selection of image data” (S102). The operation obtaining section 508 then notifies the image file analyzing section 509 of information specifying the image file thus selected (“file name”, according to the present embodiment).

Next, the image file analyzing section 509 reads out, in accordance with the “file name” notified by the operation obtaining section 508, the image file from the storing section 20, and analyzes whether or not positional information is added to the image file (S103). In a case where the image file analyzing section 509 determines that positional information is added to the image file (Yes, in S103), the display control section 507 causes the display section 40 to display an image file operation menu on which a “Security” button is displayed together with buttons such as an “Edit” button and a “Wall paper registration” button (S105). (b) of FIG. 5 is a view illustrating an example of the image file operation menu including the “Security” button.

On the other hand, in a case where the image file analyzing section 509 determines that no positional information is added to the image file (No, in S103), the display control section 507 causes the display section 40 to display a normal image file operation menu (S104).

The normal image file operation menu is a menu displayed subsequently to the image file list screen when one image file is pressed and held in a usual case (that is, in a case where no positional information is added to the one image file). Specifically, buttons such as an “Edit” button and a “Wall paper registration” button are displayed on the normal image file operation menu. However, a “Security” button is not displayed on the normal image file operation menu. Even in a case where the “Security” button is displayed, the “Security” button is in gray or the like, and cannot be selected. Note that a process, carried out after the normal image file operation menu and the normal image file operation menu are displayed, is not concerned with the feature of the present invention. Therefore, the normal image file operation menu is not illustrated. Further, the process carried out after the normal image file operation menu is displayed is not described.

Next, in a case where the “Security” button is selected on the image file operation menu including the “Security” button, the operation obtaining section 508 detects an input of “selection of security” (S106). The operation obtaining section 508 then notifies the image file analyzing section 509 of such detection.

In a case where the image file analyzing section 509 receives such notification from the operation obtaining section 508, the display control section 507 causes security setting information (a security level and an effective area), added to the selected image file, to be displayed (S107). For example, in a case where no security setting information is added to the image file, “NO” is displayed, as a default value, for each of the security level and the effective area (S107). (c) of FIG. 5 is a view illustrating an example in which the security level and the effective area are each displayed with the default value (Level: NO, Area: NO) in a case where no security setting information is added to the image file.

Next, the operation obtaining section 508 obtains, from the input section 30, a “Security Level” (for example, high, middle, low, and the like) inputted by a user (S108). (d) of FIG. 5 is a view illustrating an example of a setting screen of the “Security Level”.

Subsequently, the operation obtaining section 508 obtains, from the input section 30, an “Effective Area” (security area) (for example, 20 m, 100 m, 1000 m, and the like in radius) inputted by the user (S109). (e) of FIG. 5 is a view illustrating an example of a selection screen of the “Effective Area” (security area).

Thereafter, the operation obtaining section 508 receives an instruction signal generated by the input section 30 (S110). In a case where the operation obtaining section 508 receives a “Cancel” signal from the input section 30 (No, in S110), the screen returns to a “current security setting” screen (a screen on which a current security state of an image is displayed) (S107; see (c) of FIG. 5).

On the other hand, in a case where the operation obtaining section 508 receives an “OK” signal from the input section 30 (Yes, in S110; see (f) of FIG. 5), the operation obtaining section 508 supplies, to the security setting section 510, the “Security Level”, the “Effective Area”, each of which has been inputted by the user, and the file name of the selected image file.

Then, in accordance with information thus received from the operation obtaining section 508, the security setting section 510 stores the “Security Level” and the “Effective Area” as the security setting information in a security setting information area of the selected image file as illustrated in (a) of FIG. 17 (S111a). (g) of FIG. 5 is a view illustrating an example of a screen displayed in a case where the information received from the operation obtaining section 508 is stored as illustrated in (a) of FIG. 17.

(Flow of Switching Security Function)

The following description will discuss, with reference to FIG. 6, how the mobile phone 5 switches the security function. FIG. 6 is, as described earlier, a flowchart illustrating an example of how the mobile phones 1 and 5 each switch the security function.

First, the positional information obtaining section 501 obtains a current position from the GPS 10 (S201) (see FIG. 6).

Next, the image file extracting section 502 searches image files stored in the storing section 20, and extracts an image file whose effective area (see (a) of FIG. 17), which is added to the image file, includes the current position obtained by the positional information obtaining section 501 (S202).

Next, the image file extracting section 502 determines whether or not there is an extracted image file(s) (S203).

In a case where the image file extracting section 502 determines that there is an extracted image file (Yes, in S203), the image file extracting section 502 determines whether or not there is more than one extracted image file (S205).

In a case where the image file extracting section 502 determines that the extracted image files are plural (Yes, in S205), the image file selecting section 503 selects an image file having the highest priority among the plural extracted images.

Here, the following description will discuss, with reference to FIG. 7, a method for selecting an image file in order of priority in accordance with the present embodiment. FIG. 7 is, as described earlier, a view illustrating a basic pattern observed in a case where there are a plurality of image files whose effective areas each include a current position. Circular areas illustrated in FIG. 7 each indicate an effective area added to an image file, and a shaded area indicates a part in which the effective area overlaps with the other effective area. (a) of FIG. 7 is a view illustrating an example in which an effective area a2 added to one of two extracted image files wholly overlaps with an effective area a1 added to the other of the two extracted image files (the effective area a2 is completely included in the effective area a1). (b) of FIG. 7 is a view illustrating an example in which an effective area b1 added to one of two extracted image files partially overlaps with an effective area b2 added to the other of the two extracted image files.

The method for selecting an image file in order of priority in accordance with the present embodiment is as follows. First, in a case where the effective area a2 wholly overlaps with the effective are a1 (see (a) of FIG. 7), security setting information added to an image file having an innermost effective area (the effective area a2 in this case) becomes effective. Further, in a case where (i) there are a plurality of effective areas each of which is an innermost effective area and (ii) the plurality of effective areas (the effective areas b1 and b2 in this case) partially overlaps with each other (see (b) of FIG. 7), security setting information added to an image file whose effective area has the highest security level (the effective area b1 in this case), among the plurality of effective areas, becomes effective.

Note, however, that how to select an image file in order of priority is not limited in particular, provided that one image file is selected and security setting information added the image file is specified. For example, an image file having the highest security level can be always selected. Alternatively, an image file having the lowest security level is lowest can be always selected.

First, according to the pattern illustrated in (a) of FIG. 7, the image file selecting section 503 selects an image file having an innermost effective area, in accordance with the method for selecting an image file in order of priority (S206). Then, according to the pattern illustrated in (b) of FIG. 7, the image file selecting section 503 selects an image file whose effective area has the highest security level (S207). As a result, one image file is selected.

Specifically, for example, the image file selecting section 503 selects an image file or a plurality of image files each having an innermost effective area (see the pattern illustrated in (a) of FIG. 7). As a result, one image file or a plurality of image files whose effective areas overlap with each other is/are selected. In a case where one image file is selected, the step S207 can be omitted. In a case where a plurality of image files are selected, the image file selecting section 503 selects an image file whose effective area has the highest security level (see the pattern illustrated in (b) of FIG. 7). As a result, one image file is selected.

Thereafter, the setting information specifying section 504 specifies a security level to be set, in accordance with a security level added to the one image file thus selected (S208).

On the other hand, in a case where the image file extracting section 502 determines that there is not more than one extracted image file (that is, there is only one extracted image file) (No, in S205), the setting information specifying section 504 specifies a security level to be set, in accordance with a security level added to the one extracted image file (S208).

Further, in a case where the image file extracting section 502 determines that there is no extracted image file (No, in S203), the setting information specifying section 504 specifies a security level to be set, with reference to a security level in outside of the effective area (specifically, there is no image file whose effective area includes the current position, that is, the current position is not included in any of effective areas each added to an image file) (S204). Note that, according to the present embodiment, the security level in the outside of the effective area is always “high”. Therefore, the security level to be set is specified as “high”.

After the setting information specifying section 504 specifies the security level to be set, the setting information specifying section 504 notifies the security function control section 506 of the security level thus specified.

Next, the current setting information obtaining section 505 obtains current setting information (which indicates a current security level) from the storing section 20, and then notifies the security function control section 506 of the current setting information.

The security function control section 506 then compares the security level to be set, which security level has been notified by the setting information specifying section 504, with the current security level indicated by the current setting information, which has been notified by the current setting information obtaining section 505 (S209).

In a case where the security function control section 506 determines, as a result of the comparison, that the security level to be set is different from the current security level (Yes, in S209), the security function control section 506 changes a security state to the security level to be set (S210). The security function control section 506 then stores, in the storing section 20, the security level thus newly set, so that the current setting information is updated with the security level thus newly set. Thereafter, the control section 50 determines whether or not to end the process of switching the security function (S211).

On the other hand, in a case where the security function control section 506 determines, as a result of comparison, that the security level to be set is identical to the current security level (No, in S209), the control section 50 determines whether or not to end the process of switching the security function (S211).

In a case where the control section 50 determines to end the process of switching the security function (Yes, in S211), the control section 50 ends the process of switching the security function (S212). In a case where the control section 50 determines not to end the process of switching the security function (No, in S211), the positional information obtaining section 501 repeats obtainment of a current position from the GPS (S201).

### Sixth Embodiment

Fifth Embodiment has discussed an example in which the mobile phone 5 is configured such that security setting is carried out from an image file list screen. However, with reference to FIGS. 10, 20, and 21, the following description will specifically discuss, as Sixth Embodiment, an example in which a mobile phone 6 (information terminal) is configured such that security setting is simultaneously carried out at a time when a camera captures an image.

According to Second Embodiment, security setting information is stored on a management table (step S313) during a process of the security setting. Instead, according to Sixth Embodiment, security setting information is added to an image file, and the image file to which the security setting information is added is stored (S313a). In this point, Second Embodiment and Sixth Embodiment are different from each other.

Note that identical reference numbers are assigned to components identical to those described in Second and Fifth Embodiments, and no description of the components will be provided. Sixth Embodiment will mainly discuss differences between Sixth Embodiment and Fifth Embodiment. Components which are not specifically described here have respective configurations and functions identical to those of the components described in Second and Fifth Embodiments.

(Main Part of Configuration of Mobile Phone)

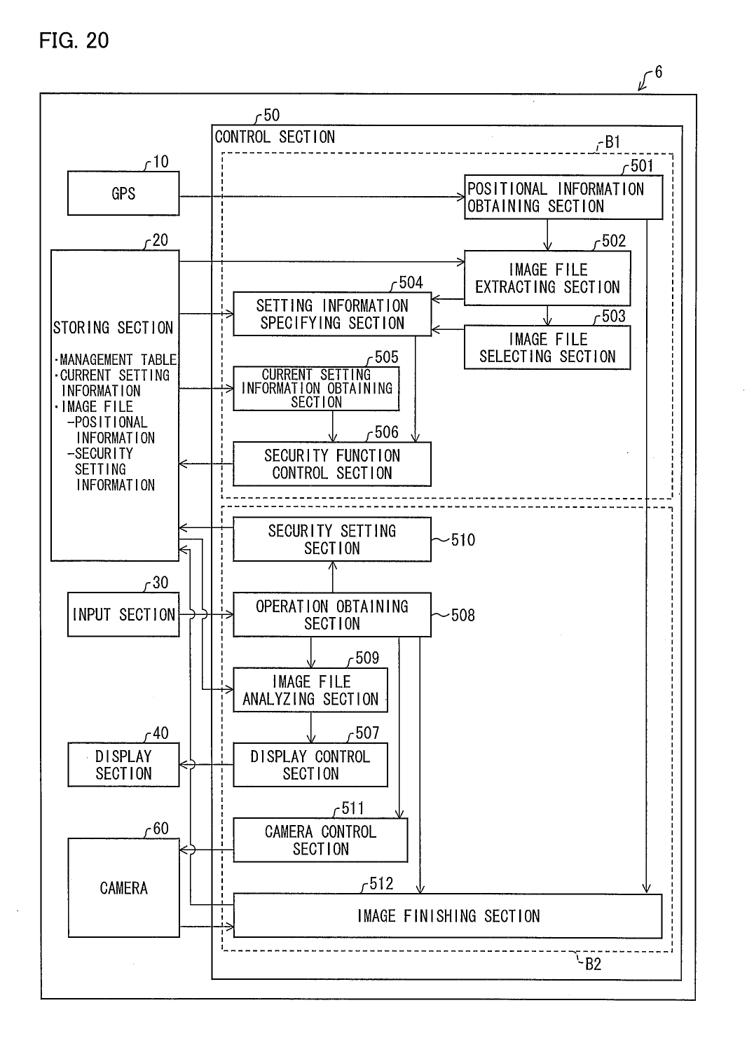

The following description will discuss, with reference to FIG. 20, a configuration of the mobile phone 6 in accordance with the present embodiment. FIG. 20 is a block diagram illustrating a main part of the configuration of the mobile phone 6.

As illustrated in FIG. 20, all the configuration of the mobile phone 6 is identical to that of the mobile phone 5 illustrated in FIG. 18, except that the mobile phone 6 further includes a camera 60, a camera control section 511 (image capturing means) serving as a block B2 of a control section 50, and an image finishing section 512 (image data generating means).

The camera 60 is configured to capture an image such as a photograph, a moving image, and the like.

The camera control section 511 activates the camera 60, and controls the camera 60 to perform image capturing.

The image finishing section 512 finishes an image file of an image captured by the camera 60 so that the image file carries positional information or no positional information, and stores the image file in a storing section 20. Note here that a positional information obtaining section 501 controls a GPS 10 to obtain the positional information at a time when, right before, or right after the camera 60 captures the image. Further, the image finishing section 512 adds security setting information to the image file thus finished.

(Flow of Security Setting)

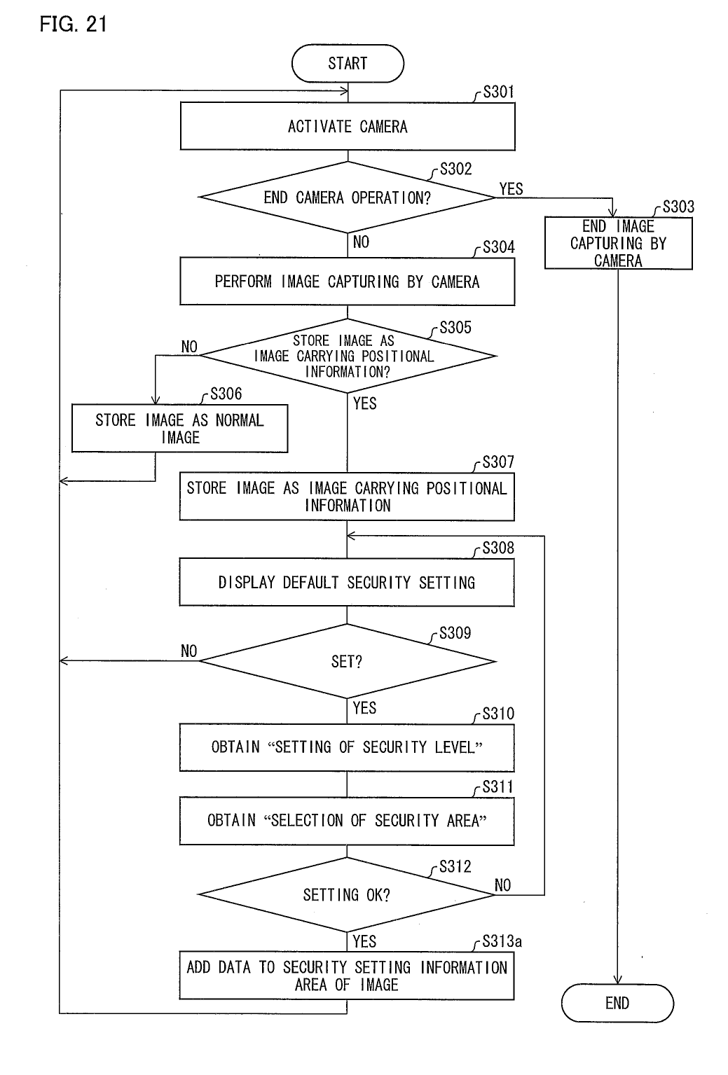

The following description will discuss, with reference to FIGS. 10 and 21, how the mobile phone 6 carries out the security setting. FIG. 21 is a flowchart illustrating an example of how the mobile phone 6 carries out the security setting. FIG. 10 is, as described earlier, a screen transition diagram illustrating an example of how the mobile phones 2 and 6 each carry out the security setting.

First, the camera control section 511 activates an image capturing process, and causes the display section 40 to display a screen which can be captured (S301) (see, FIG. 21). (a) of FIG. 10 is a view illustrating an example of a screen displayed after the image capturing process is activated.

The camera control section 511 then determines whether or not to end the image capturing process, in a case where a clear key or the like is pressed or in a case where the image capturing process times out (S302). In a case where the camera control section 511 determines to end the image capturing process (Yes, in S302), the camera control section 511 ends the image capturing process (S303).

On the other hand, in a case where (i) the camera control section 511 determines not to end the image capturing process (No, in S302) and (ii) the operation obtaining section 508 receives a capturing instruction signal from a user (in a case where the operation obtaining section 508 detects that the user has pressed a shutter), the operation obtaining section 508 notifies the camera control section 511 of the receipt of the capturing instruction signal. In a case where the camera control section 511 receives the notification from the operation obtaining section 508, the camera control section 511 causes the camera 60 to capture an image (S304).

Next, the image finishing section 512 determines whether or not to store an image file of the image thus captured as an image file carrying positional information (S305). (b) of FIG. 10 is a view illustrating an example of a screen displayed after the image is captured.

In a case where the image finishing section 512 determines not to store the image file of the image thus captured as the image carrying positional information (No, in S305), the image finishing section 512 stores, in the storing section 20, the image file as a normal image file (an image file carrying no positional information) (S306). Then, the display control section 507 causes the display section 40 to display a screen which can be captured after the camera is activated (see (h) of FIG. 10) (S301).

On the other hand, in a case where the image finishing section 512 determines to store the image file of the image thus captured as the image file carrying positional information (Yes, in S305), the image finishing section 512 obtains a current position from the positional information obtaining section 501, then adds the current position to the image file, and stores, in the storing section 20, the image file to which the current position is added (S307).

Next, the display control section 507 causes the display section 40 to display default security setting information (S308). The default security setting information is information in which a security level and an effective area are each indicated by “No”. That is, neither of the security level nor the effective area is set. (c) of FIG. 10 is a view illustrating a screen on which the default security setting information is displayed.

Next, the operation obtaining section 508 determines whether or not the user has selected a “Setting” button (see (c) of FIG. 10) (S309).

In a case where the operation obtaining section 508 detects that the user has selected a “Cancel” button (see (c) of FIG. 10) (that is, the user has not selected the “Setting” button) (No, in S309), the display control section 507 causes the display section 40 to display a screen which can be captured after the camera is activated (see (h) of FIG. 10) (S301).

On the other hand, in a case where the operation obtaining section 508 detects that the user has selected the “Setting” button (Yes, in S309), the operation obtaining section 508 obtains, from an input section 30, a “Security Level” (for example, high, middle, low, and the like) inputted by the user (S310). (d) of FIG. 10 is a view illustrating an example of a setting screen of the “Security Level”.

Then, the operation obtaining section 508 obtains, from the input section 30, an “Effective Area” (security area) (for example, 20 m, 100 m, 1000 m, and the like in radius) inputted by the user (S311). (e) of FIG. 10 is a view illustrating an example of a selection screen of the “Effective Area” (security area).

The operation obtaining section 508 then determines a user input signal supplied from the input section 30 (S312). In a case where the operation obtaining section 508 receives a “Cancel” signal from the input section 30 (No, in S312), the screen returns to a screen on which the default security setting information is displayed (S308; see (c) of FIG. 10).

On the other hand, in a case where the operation obtaining section 508 receives an “OK” signal from the input section 30 (Yes, in S312; see (f) of FIG. 10), the operation obtaining section 508 supplies, to the security setting section 510, the “Security Level”, the “Effective Area”, each of which has been inputted by the user, and a file name of the selected image file.

Then, in accordance with information thus received from the operation obtaining section 508, the security setting section 510 adds security setting information to the selected image file, and stores the selected image file to which the security setting information is added (S313a). (g) of FIG. 10 is a view illustrating an example of a screen displayed in a case where the information received from the operation obtaining section 508 is added to the selected image file and the selected image file to which the security setting information is added is stored.

Thereafter, the display control section 507 causes the display section 40 to display a screen which can be captured after the camera is activated (see (h) of FIG. 10) (S301).

### Seventh Embodiment

Fifth and Sixth Embodiments have discussed examples in which the mobile phones 5 and 6 are configured such that a security level and an effective area are selected by a user and then security setting is carried out. However, with reference to FIGS. 11 to 14, the following description will specifically discuss, as Seventh Embodiment, an example in which a mobile phone 7 (information terminal) is configured such that security setting is carried out by dropping an image file to a setting folder which is prepared in advance and which is made up of a combination of a security level and an effective area.

Note that identical reference numbers are assigned to components identical to those described in Fifth Embodiment, and no description of the components will be provided. Seventh Embodiment will mainly discuss differences between Seventh Embodiment and Fifth Embodiment. Components which are not specifically described here have respective configurations and functions identical to those of the components described in Fifth Embodiment.

(Main Part of Configuration of Mobile Phone)

All configuration of the mobile phone 7 is identical to that of the mobile phone 5 illustrated in FIG. 18. Therefore, no description of the configuration of the mobile phone 7 is provided.

(Flow of Security Setting)

The following description will discuss, with reference to FIGS. 11 and 12, how the mobile phone 7 carries out the security setting. FIG. 11 is, as described earlier, a flowchart illustrating an example of how the mobile phones 3 and 7 each carry out the security setting. FIG. 12 is, as described earlier, a screen transition diagram illustrating an example of how the mobile phones 3 and 7 each carry out the security setting.

First, a display control section 507 makes a list of setting folders and a list of image files stored in the mobile phone 3, and controls a display section 40 to display those lists as a security setting screen (S401) (see FIG. 11). (a) of FIG. 12 is a view illustrating an example of the security setting screen displayed on the display section 40.

The following description will discuss the setting folders with reference to FIG. 13. FIG. 13 is a tree chart illustrating a relationship between the setting folders and the image files. According to the present embodiment, the setting folders are present together with the image files under an image folder. By moving an image file carrying positional information, among the image files, to one of the setting folders, the security setting is carried out.

Note here that, in a case where security setting information (security level and effective area) is already added to an image file present under a setting folder, security setting information assigned to the setting folder, under which the image file is present, is employed more preferentially than the security setting information added to the image file, when the security setting is carried out. That is, irrespective of whether or not the security setting information is added to the image file present under the setting folder, the security setting information is determined by the setting folder under which the image file is present, and then the security setting is carried out. For example, according to an image file present under a setting folder “high, 20 m”, a security level is always set to “high” in an effective area within a “20-meter” radius from a position indicated by positional information added to the image file.

Note that an image file carrying no positional information can be controlled not to be dropped to a setting folder on an operation screen or can be controlled not to be displayed on the security setting screen. Alternatively, an image file carrying positional information and a normal image file carrying no positional information can be simply displayed so that they can be distinguished from each other.

Next, an operation obtaining section 508 determines whether or not to end the security setting in a case where it is detected that a clear key or the like is pressed (S402). In a case where the operation obtaining section 508 determines to end the security setting (Yes, in S402), a control section 50 ends display of the security setting screen.

On the other hand, in a case where the operation obtaining section 508 determines not to end the security setting (No, in S402), the operation obtaining section 508 determines whether or not an image file carrying positional information has been dropped to one of the setting folders (S403).

In a case where the operation obtaining section 508 determines that the image file carrying positional information has not been dropped to any of the setting folders (No, in S403), a display control section 507 controls the display section 40 to continue to display the security setting screen (S401).

On the other hand, in a case where the operation obtaining section 508 determines that the image file carrying positional information has been dropped to one of the setting folder (see (b) of FIG. 10) (Yes, in S403), a security setting section 510 carries out the security setting by moving the image file carrying positional information to the one of the setting folder (see (c) of FIG. 10) (S404).

Thereafter, the display control section 507 controls the display section 40 to continue to display the security setting screen (see (d) of FIG. 10) (S401).

(Flow of Switching Security Function)

The following description will discuss, with reference to FIG. 14, how the mobile phone 7 switches security function. FIG. 14 is, as described earlier, a flowchart illustrating an example of how the mobile phones 3 and 7 each switch the security function.

First, a positional information obtaining section 501 obtains a current position from a GPS 10 (S601) (see FIG. 14).

Next, an image file extracting section 502 searches image files present under each of the setting folders, and extracts an image file whose effective area derived from a setting folder under which the image file is present includes the current position obtained by the positional information obtaining section 501 (S602).

Next, the image file extracting section 502 determines whether or not there is an extracted image file(s) (S603).

In a case where the image file extracting section 502 determines that there is no extracted image file (No, in S603), a setting information specifying section 504 specifies a security level to be set, with reference to a security level in outside of the effective area (S604). In the present embodiment, the security level in the outside of the effective area is always “high”.

On the other hand, in a case where the image file extracting section 502 determines that there is an extracted file (Yes, in S603), the image file extracting section 502 determines whether or not there is more than one extracted image file (S605).

In a case where the image file extracting section 502 determines that the extracted image files are plural (that is, there is more than one image file) (Yes, in S605), the image file selecting section 503 selects one image file having the highest priority, among the plural extracted images, in accordance with the method for selecting an image file in order of priority described in Fifth Embodiment with reference to FIG. 7. Specifically, according to the pattern illustrated in (a) of FIG. 7, the image file selecting section 503 first selects an image file having an innermost effective area (S606). Then, according to the pattern illustrated in (b) of FIG. 7, the image file selecting section 503 selects an image file whose effective area has the highest security level (S607). As a result, one image file is selected.

Thereafter, the setting information specifying section 504 specifies a security level to be set, in accordance with a folder name of a setting folder including the one image file thus selected (S608).

On the other hand, in a case where the image file extracting section 502 determines that there is not more than one extracted image file (that is, there is only one extracted image file) (No, in S605), the setting information specifying section 504 specifies a security level to be set, in accordance with a folder name of a setting folder including the one extracted image file (S608).

After the setting information specifying section 504 specifies the security level to be set, the setting information specifying section 504 notifies a security function control section 506 of the security level thus specified.

Next, the current setting information obtaining section 505 obtains current setting information (which indicates a current security level) from a storing section 20, and then notifies the security function control section 506 of the current setting information.

The security function control section 506 then compares the security level to be set, which security level has been notified by the setting information specifying section 504, with the current security level indicated by the current setting information, which has been notified by the current setting information obtaining section 505 (S609).

In a case where the security function control section 506 determines, as a result of the comparison, that the security level to be set is different from the current security level (Yes, in S609), the security function control section 506 changes a security state to the security level to be set (S610). The security function control section 506 then stores, in the storing section 20, the security level thus newly set, so that the current setting information is updated with the security level thus newly set. Thereafter, the control section 50 determines whether or not to end the process of switching the security function (S611).

On the other hand, in a case where the security function control section 506 determines, as a result of comparison, that the security level to be set is identical to the current security level (No, in S609), the control section 50 determines whether or not to end the process of switching the security function (S611).

In a case where the control section 50 determines to end the process of switching the security function (Yes, in S611), the control section 50 ends the process of switching the security function (S612). In a case where the control section 50 determines not to end the process of switching the security function (No, in S611), the positional information obtaining section 501 repeats obtainment of a current position from the GPS 10 (S601).

Note that, in the above description, an image file is actually moved to a setting folder by moving the image file on a screen. However, without actually moving the image file, security setting information (security level, effective area) added to the image file can be simply rewritten to security setting information assigned to the setting folder to which the image file is moved on the screen. This reduces time and effort to actually move the image file and, therefore, allows an increase in processing speed.

### Eighth Embodiment

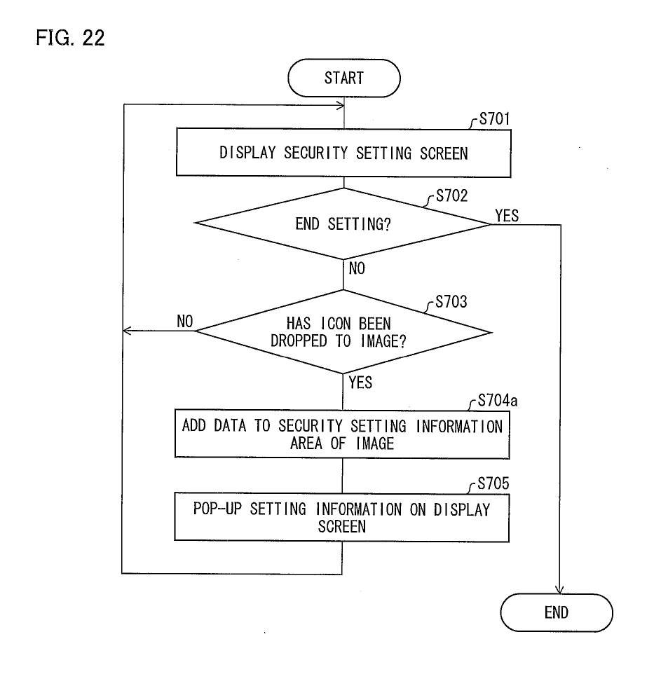

Seventh Embodiment has discussed an example in which the mobile phone 7 is configured such that security setting is carried out by dropping an image file to a setting folder. However, with reference to FIGS. 16 and 22, the following description will specifically discuss, as Eighth Embodiment, an example in which a mobile phone 8 (information terminal) is configured such that security setting is carried out by dropping, to an image file, an icon which is prepared in advance and which is made up of a combination of a security level and an effective area.

According to Fourth Embodiment, security setting information is stored on a management table (step S704) during a process of security setting. Instead, according to Eighth Embodiment, security setting information is added to an image file, and the image file to which the security setting information is added is stored (S704a). In this point, Eighth Embodiment and Fourth Embodiment are different from each other.

Note that the present embodiment is not limited to such an arrangement that the security setting is carried out by dropping the icon to the image file. For example, the security setting can be carried out by dropping the image file to the icon.

Further, identical reference numbers are assigned to components identical to those described in Fourth and Fifth Embodiments, and no description of the components will be provided. Eighth Embodiment will mainly discuss differences between Eighth Embodiment and Fifth Embodiment. Components which are not specifically described here have respective configurations and functions identical to those of the components described in Fourth and Fifth Embodiments.

(Flow of Security Setting)

The following description will discuss, with reference to FIGS. 16 and 22, how the mobile phone 8 carries out the security setting. FIG. 22 is a flowchart illustrating an example of how the mobile phone 8 carries out the security setting. FIG. 16 is, as described earlier, a screen transition diagram illustrating an example of how the mobile phones 4 and 8 each carry out security setting.

First, a display control section 507 makes a list of icons and a list of image files stored in the mobile phone 8, and then controls a display section 40 to display, as a security setting screen, the list of the icons and the list of the image files (S701) (see FIG. 22). (a) of FIG. 16 is a view illustrating an example of the security setting screen displayed on the display section 40. For example, an icon displayed with “high, 100” is an icon with which a security level is set to “high” in an effective area within a “100-meter” radius from a position indicated by positional information added to an image file to which the icon is dropped. As just described, the list of the icons, to which respective security settings are assigned, is displayed on a display screen together with the list of the image files.

Note that an image file carrying no positional information can be displayed in gray and controlled so that an icon cannot be dropped to the image file. Alternatively, the image file carrying no positional information can be controlled not to be displayed on the security setting screen. Further, an image file carrying positional information and a normal image file carrying no positional information can be simply displayed so that they can be distinguished from each other.

Next, an operation obtaining section 508 determines whether or not to end the security setting in a case where a clear key or the like is pressed (S702). In a case where the operation obtaining section 508 determines to end the security setting (Yes, in S702), a control section 50 ends display of the security setting screen.

On the other hand, in a case where the operation obtaining section 508 determines not to end the security setting (No, in S702), the operation obtaining section 508 determines whether or not an icon has been dropped to an image file carrying positional information (S703).

In a case where the operation obtaining section 508 determines that the icon has not been dropped to the image file carrying positional information (No, in S703), the display control section 507 controls the display section 40 to continue to display the security setting screen (S701).

On the other hand, in a case where the operation obtaining section 508 determines that the icon has been dropped to the image file carrying positional information (see (b) of FIG. 16) (Yes, in S703), a security setting section 510 adds, in accordance with security setting information indicated by the icon which has been dropped to the image file, the security setting information to the image file to which the icon is dropped, and stores the image file to which the security setting information is added (S704a).

Next, the display control section 507 controls the display section 40 to pop up, on the security setting screen, the security setting information thus stored (see (c) of FIG. 16) (S705).

Thereafter, the display control section 507 controls the display section 40 to continue to display the security setting screen (see (a) of FIG. 16) (S701).

[Supplementary Notes]

The present invention is not limited to the description of the embodiments above, but may be altered by a skilled person within the scope of the claims. An embodiment derived from a proper combination of technical means disclosed in different embodiments is also encompassed in the technical scope of the present invention.

Finally, each block of the mobile phones 1 to 8, particularly the control section 50, can be configured by hardware logic. Alternatively, each block of the mobile phones 1 to 8, particularly the control section 50, can be realized by software with the use of a CPU as below.

That is, each of the mobile phone 1 to 8 includes (i) a CPU which executes a command of a control program that carries out each function of the each of the mobile phones 1 to 8, (ii) a ROM in which the control program is stored, (iii) a RAM which extracts the control program in executable form, and (iv) a storage device (recording medium), such as a memory, in which the control program and various sets of data are stored. The object of the present invention can be attained by (i) supplying, to each of the mobile phones 1 to 4, a recording medium in which program codes (an executable program, an intermediate code program, and a source program) of the control program of each of the mobile phones 1 to 8, which is software that carries out each function, are computer-readably recorded and (ii) causing a computer (or a CPU or an MPU) of the each of the mobile phones 1 to 8 to read and carry out the program codes recorded in the recording medium.

Examples of the recording medium include: (i) tapes such as a magnetic tape and a cassette tape; (ii) disks including magnetic disks, such as a floppy (Registered Trademark) disk and a hard disk, and optical disks, such as a CD-ROM, an MO, an MD, a DVD, and a CD-R; (iii) cards such as an IC card (including a memory card) and an optical card; and (iv) semiconductor memories such as a mask ROM, EPROM, EEPROM (Registered Trademark), and a flash ROM.

Further, each of the mobile phones 1 to 8 can be connected to a communication network so that the program codes are supplied to the each of the mobile phones 1 to 8 via the communication network. This communication network is not limited to any particular one. Examples of the communication network include the Internet, an intranet, an extranet, a LAN, ISDN, VAN, a CATV communications network, a virtual private network, a telephone network, a mobile telecommunications network, and a satellite communication network. Further, a transmission medium by which the communication network is constituted is not limited to any particular one. Examples of the transmission medium include: wired transmission media such as IEEE1394, a USB, a power-line carrier, a cable TV circuit, a telephone line, and ADSL; and wireless transmission media such as infrared communication systems such as IrDA and a remote control, Bluetooth (Registered Trademark), 802.11 wireless communication system, HDR, a mobile phone network, a satellite circuit, and a digital terrestrial network.

As has been described, the information terminal of the present invention includes a plurality of applications, the function limit setting information, which is associated with the image data carrying positional information, including a content of a limitation on which function of the plurality of applications is allowed to use.

According to the above configuration, it is possible to limit the function of each of the plurality of applications by extracting one set of image data carrying positional information. Therefore, function limit is easily set or changed.

Further, the information terminal of the present invention is arranged such that the storing section includes a folder or folders for each piece of function limit setting information, respectively; and the function limit setting means (i) causes the display section to display the folder or one of the folders, and the image data carrying positional information and (ii) associates the function limit setting information, which is assigned to the folder or the one of the folders, with the image data carrying positional information which image data is moved to the folder or the one of the folders by a user.

According to the above configuration, the folder or the folders is/are prepared for each piece of function limit setting information, respectively. Therefore, all sets of image data carrying positional information present under the folder or the one of the folders are each associated with the function limit setting information assigned to the folder or the one of the folders.

Therefore, data is not necessary, such as a management table on which the image data carrying positional information and the function limit setting information are managed in association. This allows a memory to be saved. Further, the function limit is set or changed by a user's operation of moving the image data between the folders. Therefore, the user can intuitively and easily set or change the function limit.

The information terminal of the present invention further includes: image capturing means for capturing an image and generating image data of the image; position obtaining means for obtaining a current position of the information terminal at a time when the image capturing means captures the image; and positional information-carrying image data generating means for generating the image data carrying positional information by adding, to the image data generated by the image capturing means, positional information indicative of the current position obtained by the position obtaining means.

According to the above configuration, it is possible to easily generate the image data carrying positional information, the image data being image data (i) which is of an object located at a position at which the user desires to set the function limit and (ii) to which positional information such as a longitude and a latitude of the position is added. This facilitates an operation of setting or changing the function limit by associating the function limit setting information and the positional information with each other.

Further, the information terminal of the present invention is arranged such that the function limit setting means (i) adds the function limit setting information thus specified to the image data carrying positional information and (ii) stores, in the storing section, the image data carrying positional information and the function limit setting information.

According to the above configuration, the function limit setting information indicative of a content of a limitation on a function of the information terminal is added to the image data carrying positional information, and the image data carrying positional information, to which the function limit setting information is added, is stored in the storing section. Therefore, according to the information terminal, in a case where the function of the information terminal is limited in accordance with the current position of the information terminal, it is possible to limit the function of the information terminal with the use of the function limit setting information added to the image data carrying positional information to which image data the positional information indicative of a position near the current position is added, with reference to the positional information added to the image data carrying positional information.

Particularly, according to the information terminal, it is not the positional information but the image data that is directly associated with the function limit setting information. This allows the user to set or change the function limit while looking at the image, in a case where the user sets or changes the function limit by associating the function limit setting information with the positional information. Since the user can specifically recognize, as an image, which place the position indicated by the positional information indicates, the user can easily set or changes the function limit. Obviously, the image data carrying positional information is preferably image data (i) which is of an object located at a position at which the user desires to set the function limit and (ii) to which positional information such as a longitude and a latitude of the position is added.

Further, the function limit setting information is added to the image data together with the positional information. Therefore, data is not necessary, such as a management table on which the positional information (or the image data carrying positional information) and the function limit setting information are managed in association. This allows a memory to be saved.

Furthermore, it is possible to share the function limit setting information added to the image data by sharing the image data. For example, in a case where the user desires to set a function limit identical to the above on another information terminal, the user is not necessary to set the function limit again on the another information terminal. It is possible to set the identical function limit on the another information terminal only by receiving, by the another information terminal, the image data to which the function limit setting information is added. This reduces use's time and effort and, accordingly, allows an increase in convenience.

Further, the information terminal of the present invention includes a plurality of applications, the function limit setting information, which is added to the image data carrying positional information, including a content of a limitation on which function of the plurality of applications is allowed to use.

According to the above configuration, it is possible to limit the function of each of the plurality of applications by extracting one set of image data carrying positional information. Therefore, the function limit is easily set or changed.

Further, the information terminal of the present invention is arranged such that the image data carrying positional information is associated with a second function limit setting information which is different from the function limit setting information added to the image data carrying positional information and which indicates a content of a limitation on the function of the information terminal.

According to the above configuration, there is the second function limit setting information associated with the image data, apart from the function limit setting information. Thus, one set of image data can be associated with the second function limit setting information different in content from the function limit setting information. This makes it possible to selectively employ, in order of priority, the function limit setting information added to the image data and the second function limit setting information. For example, the second function limit setting information associated with the image data can be higher in priority than the function limit setting information added to the image data.

Therefore, in a case where the user desires to temporarily change the function limit, the user is only necessary to employ the second function limit setting information without changing the function limit setting information added to the image data, that is, the image data carrying positional information. On the other hand, in a case where the user desires to change back the function limit, the user is only necessary to delete the second function limit setting information or cancel the association between the second function limit setting information and the image data carrying positional information. This reduces time and effort to change and reset the function limit setting information over and over again and, accordingly, allows an increase in user convenience.

Further, it is not necessary to update the function limit setting information added to the image data. Therefore, an increase in overall processing speed can be expected.

Further, the information terminal of the present invention is arranged such that the storing section includes a folder or folders for each piece of second function limit setting information, respectively; and the function limit setting means (i) causes the display section to display the folder or one of the folders, and the image data carrying positional information and (ii) associates the second function limit setting information, which is assigned to the folder or the one of the folders, with the image data carrying positional information which image data is moved to the folder or the one of the folders by a user.

According to the above configuration, the folder or the folders is/are prepared for each piece of second function limit setting information, respectively. Therefore, all sets of image data carrying positional information present under the folder or the one of the folders are each associated with the second function limit setting information assigned to the folder or the one of the folders.

Therefore, data is not necessary, such as a management table on which the positional information (or the image data carrying positional information) and the second function limit setting information are managed in association. This allows a memory to be saved.

Further, in a case where the user desires to temporarily change the function limit, the user can easily change the function limit only by moving the image data to the setting folder. On the other hand, in a case where the user desires to change back the function limit, the user is only necessary to move the image data out of the setting folder. As just described, the user is only necessary to move the image data between the setting folders. Therefore, the user can intuitively and easily set or change the function limit. Further, it is not necessary to update the function limit setting information added to the image data. Therefore, an increase in overall processing speed can be expected.

### INDUSTRIAL APPLICABILITY

The present invention is applicable to information terminals. Particularly, the present invention is preferably applicable to information terminals each of which has a security function and each of which switches a security level in accordance with a position.

### REFERENCE SIGNS LIST

1, 2, 3, 4, 5, 6, 7, 8 Mobile phone (information terminal)
20 Storing section
40 Display section
501 Positional information obtaining section (position obtaining means)
510 Security setting section (function limit setting means)
511 Camera control section (image capturing means)
512 Image finishing section (image data generating means)

1. An information terminal which limits a function of the information terminal in accordance with a current position of the information terminal, comprising:
a display section for displaying an image;
a storing section for storing image data carrying positional information, the image data being image data to which positional information is added; and
a function limit setting means for (i) causing the display section to display an image of the image data carrying positional information, (ii) specifying function limit setting information indicative of a content of a limitation on a function of the information terminal, and (iii) storing, in the storing section, the function limit setting information in association with the image data carrying positional information.

2. An information terminal as set forth in claim 1, further comprising:
a plurality of applications,
the function limit setting information, which is associated with the image data carrying positional information, including a content of a limitation on which function of the plurality of applications is allowed to use.

3. The information terminal as set forth in claim 1, wherein:
the storing section includes a folder or folders for each piece of function limit setting information, respectively; and
the function limit setting means (i) causes the display section to display the folder or one of the folders, and the image data carrying positional information and (ii) associates the function limit setting information, which is assigned to the folder or the one of the folders, with the image data carrying positional information which image data is moved to the folder or the one of the folders by a user.

4. An information terminal as set forth in claim 1, further comprising:
image capturing means for capturing an image and generating image data of the image;
position obtaining means for obtaining a current position of the information terminal at a time when the image capturing means captures the image; and
positional information-carrying image data generating means for generating the image data carrying positional information by adding, to the image data generated by the image capturing means, positional information indicative of the current position obtained by the position obtaining means.

5. The information terminal as set forth in claim 1, wherein the function limit setting means (i) adds the function limit setting information thus specified to the image data carrying positional information and (ii) stores, in the storing section, the image data carrying positional information and the function limit setting information.

6. An information terminal as set forth in claim 5, further comprising:
a plurality of applications,
the function limit setting information, which is added to the image data carrying positional information, including a content of a limitation on which function of the plurality of applications is allowed to use.

7. The information terminal as set forth in claim 5, wherein the image data carrying positional information is associated with a second function limit setting information which is different from the function limit setting information added to the image data carrying positional information and which indicates a content of a limitation on the function of the information terminal.

8. The information terminal as set forth in claim 7, wherein:
the storing section includes a folder or folders for each piece of second function limit setting information, respectively; and
the function limit setting means (i) causes the display section to display the folder or one of the folders, and the image data carrying positional information and (ii) associates the second function limit setting information, which is assigned to the folder or the one of the folders, with the image data carrying positional information which image data is moved to the folder or the one of the folders by a user.

9. (canceled)

10. A non-transitory computer readable recording medium in which the control method recited in claim 11 is recorded.

11. A method for controlling an information terminal which limits a function of the information terminal in accordance with a current position of the information terminal,
the information terminal comprising: a display section for displaying an image; and a storing section for storing image data carrying positional information, the image data being image data to which positional information is added,
the method comprising the steps of (i) causing the display section to display an image of the image data carrying positional information, (ii) specifying function limit setting information indicative of a content of a limitation on a function of the information terminal and (iii) storing, in the storing section, the function limit setting information in association with the image data carrying positional information.
